(19) United States
(12) Patent Application Publication
(10) Pub. No.: US 2010/0098805 A1
(43) Pub. Date: Apr. 22, 2010

(54) Probiotic Oat-Based Food Product and Process for Making the Same

(75) Inventor: Sergey Vladimirovich Vykhodtsev, Moscow (RU)

Correspondence Address: FISH & RICHARDSON P.C., PO BOX 1022, MINNEAPOLIS, MN, 55440-1022, US

(73) Assignee: VELLE RW LTD., Limassol (CY)

(21) Appl. No.: 12/521,293

(22) PCT Filed: Dec. 20, 2007
(86) PCT No.: PCT/EP2007/011299

§ 371 Date: Jun. 25, 2009

(30) Foreign Application Priority Data
Dec. 25, 2006 (RU) RU 2006 146658
Dec. 25, 2006 (RU) RU 2006 146659
Nov. 30, 2007 (GB) 0723581.5

(51) Int. Cl. A23L 1/186; A23L 1/105

(52) U.S. Cl. 426/28; 426/18; 426/61

(57) ABSTRACT

The present invention provides a process for preparing a pro-biotic oat-based fluid food product, the process comprising: A) a first fermentation step, involving the fermentation of oat material; B) mechanically treating one or more unfermented oat-derived substances in the presence of water to form an aqueous suspension containing 1,3-1,4 β D-glucan in dissolved and/or suspended form, wherein the average molecular weight of the 1,3-1,4 β D-glucan in the suspension is at least 1,500,000 Daltons, and combining the products from the first fermentation step with the one or more oat-derived substances and the water, before, during or after the formation of the aqueous suspension; and C) a second fermentation step, involving the fermentation of the aqueous suspension in the presence of Lactobacteria and/or Bifidobacteria, until the quantity of Lactobacteria is at least 10E7 CFU/g and/or the quantity of Bifidobacteria is at least 10E7 CFU/g. The present invention further provides products obtainable by this process.

The present invention relates to an oat-based probiotic food product and a process for making it. In particular, the present invention relates to an oat-based probiotic food product that contain high-molecular weight 1,3-1,4 β D-glucan in a readily bioavailable form.

Probiotic foods contain live microorganisms that are beneficial to humans. Such microflora include yeast and certain types of bacteria. It is believed that these microorganisms help the body's natural gut microflora to grow and/or increase their metabolic activity, which in turn has a beneficial effect on the body's physiological, biochemical and immune systems.

Prebiotics are non-microbial substances that can exert a beneficial effect on the human body, again by helping the body's natural gut microflora to grow and/or by increasing their metabolic activity. They may be used in combination with probiotic microorganisms. Examples of prebiotic substances include plant-derived edible fibres and their constituents, which can be both soluble (i.e. able to dissolve in water, e.g. certain types of β D-glucans) and insoluble (e.g. cellulose, which can be found in the walls of plant cells).

It is known that soluble edible fibres increase the binding and elimination from the body of bile acids, neutral steroids, including cholesterol, and reduce absorption of cholesterol and fats in the small intestine. They inhibit or slow the synthesis of cholesterol, lipoproteins and fatty acids in the liver, and they speed up the synthesis of lipase, an enzyme responsible for the breakdown of fat, in the adipose tissue, and they therefore have a beneficial influence on lipid metabolism. The World Health Organization recommends a daily consumption of at least 30 g of edible fibre, both insoluble and soluble.

Theoretical and practical medicine assumes that regular consumption of food fibre plays a considerable role in preventing a number of diseases, since it normalizes the metabolism, the functions of the GI tract, of the pancreas, and the body's immune reactions.

It should be pointed out, however, that although the useful properties of food fibre are known, enrichment of food products with food fibre is an inadequately studied area of science and there has been little practical investigation.

Accordingly, there has been a recent focus on the production of a food product containing natural edible fibres. Food products derived from oats are of particular interest, since oats contain a considerable quantity of soluble edible fibres, particularly 1,3-1,4 β D-glucan, as well as insoluble fibres such as cellulose.

A biologically active food product is disclosed in Russian patent 2189153, 2000. This food product is made by fermenting cereals with lactobacteria. The method of production involves (i) grinding cereal grains, such as oats, wheat, rice or a mixture of oat groats with wheat bran, (ii) introduction of a starter culture containing lactobacilli such as the preparation “Lactobacterin”, or “Acylact” or “Narine”, (iii) fermentation of the mixture for 1-3 days, and (iv) removal of the supernatant to obtain the target food product containing 39.78% protein by weight (as dry matter).

The above method, while able to produce relatively small quantities of a probiotic food, is not reproducible industrially. Additionally, the shelf life of the product has been found to be relatively short. Furthermore, the supernatant, which is believed would contain some beneficial soluble fibres, is removed after fermentation. Consequently, the final food product contains a relatively low amount of soluble fibres.

One of the further drawbacks of the method of this Russian patent is that it does not produce a product with a guaranteed minimum content of lactobacteria. Further, the number of lactobacteria can decline in the product to a low level after the fermentation step. The content of cellulose and soluble edible fibres has also been found to vary in final product from batch to batch. This is believed to be because the concentration of insoluble and soluble edible fibres present in the final food product depends to a large extent on the amount of these fibres in the cereal grains used. There is no guidance in this document of how one could produce a product having a desired minimum level of insoluble or soluble fibres.

WO 9117672 discloses a food product obtained by fermenting oat bran using microorganisms. This food product is made by fermenting cereal bran (from barley, wheat, rice and millet) in an aqueous mixture using live lactobacilli microorganisms. These microorganisms include species such as Lactobacillus or other lactic-acid bacteria, propionic-acid bacteria, and other similar bacteria. Particular microorganisms include: Lactobacillus GG, Lactobacillus acidophilus, Lactobacillus bulgaricus, Lactobacillus sp., Lactobacillus thermophilus, Lactobacillus casei and Streptococcus sp.

The food product produced using the process disclosed in WO 9117672 has a pH of 3.5-5 and is characterized by a basic composition containing 5-25% dry matter; 0.3-1.0% lactic acid; calorific value 50-150 kJ/100 g; dietary cellulose: 10-30 g/100 g (based on dry matter); and Lactobacilli:10E5 CFU/g.

The food product described in WO 9117672 can also be characterized by a basic composition containing 5-15% dry matter; 0.3-1.0% lactic acid; calorific value 50-150 kJ/100 g; dietary cellulose 10-30 g/100 g (based on dry matter); and Lactobacilli 10E5-8 CFU/g.

The microorganisms used for the fermentation in WO 9117672 are known, and they are selected on the basis of the technology and product quality, and the raw material used comprises a mixture of oatmeal, barley, wheat, rice, millet or bran, vegetables, fruit, or berries.

In the process of WO 9117672, the raw material is heated without any kind of preliminary treatment to 100° C. The present inventors have found that above 68° C. there is an inevitable dextrinization of starch molecules in the cereal grains, which blocks the exit of 1,3-1,4 β D-glucan from the cellular structures during subsequent heat treatment, and prevents maximum hydration and colloidization of the glucan. It seems that the process allows the extraction of 1,3-1,4 β D-glucan only from the outermost damaged cells of the bran. Accordingly, the percentage by weight of high molecular 1,3-1,4 β D-glucan in the final product will be relatively low. Additionally, even if high molecular weight glucan is present in the product, it is most likely still in cells of the cereal material, not in a desired dissolved or colloidal form. Consequently, it will not be so readily bioavailable.

WO2007/003688 discloses a process for preparing a food substance containing beta-glucan. The process involves (i) heat-treating beta-glucan rich material and water at a temperature of 75 to 140° C. to gelatinize the starch contained in the material, (ii) cooling the suspension and (iii) grinding the cooled suspension to form a stable food suspension. The process results in a product containing 0.25 g/100 g of beta glucan.

However, this is considered to be relatively low molecular weight beta-glucan. This document states that the product contains beta-glucan having a molecular weight of from 10000 to 2,000,000 Daltons. As above for WO 9117672, the initial heat treatment step is believed to prevent the extraction of high molecular weight 1,3-1,4 β D-glucan from the cells of the cereal. Therefore, only a very small amount, if any, of beta glucan having a molecular weight above 2,000,000 Daltons is present in the final product in dissolved or suspended form. The average molecular weight of the 1,3-1,4 β D-glucan in a product produced using the process in WO2007/003688 would be much less than 1,500,000 Daltons. The process of WO2007/003688 may also include a step of fermenting the suspension with microorganisms, such as yeast, lactic acid bacteria, bifidobacteria and propionic bacteria.

It is an object of the present invention to overcome or at least mitigate at least one of the problems associated with the prior art.

Accordingly, in a first aspect, the present invention provides a process for preparing a pro-biotic oat-based fluid food product, the process comprising:
A) a first fermentation step, involving the fermentation of oat material;
B) mechanically treating one or more unfermented oat-derived substances in the presence of water to form an aqueous suspension containing 1,3-1,4 β D-glucan, preferably having an average molecular weight of at least 1,500,000 Daltons, in dissolved and/or suspended form, and combining the products from the first fermentation step with the one or more oat-derived substances and the water, before, during or after the formation of the aqueous suspension; and
C) a second fermentation step, involving the fermentation of the aqueous suspension in the presence of Lactobacteria and/or Bifidobacteria, until the quantity of Lactobacteria is at least 10E7 CFU/g and/or the quantity of Bifidobacteria is at least 10E7 CFU/g.

In a second aspect, the present invention provides a probiotic oat-based fluid food product comprising
a. 1,3-1,4 β D-glucan, wherein preferably the average molecular weight of the 1,3-1,4 β D-glucan in the product is at least 1,500,000 Daltons;
b. 2.5 to 40 wt % solids, at least some of which is derived from oats;
c. at least 10E7 CFU/g Lactobacteria and/or at least 10E7 CFU/g Bifidobacteria;
d. with the remainder water.

The process of the present invention has been found to have considerable advantages over the processes of the prior art. In particular, the primary fermentation has unexpectedly been found to promote the secondary fermentation. It is believed that the primary fermentation of the oat ingredients produces a number of nutrients and growth factors that promote the growth of Lactobacteria and/or Bifidobacteria.

Furthermore, the process preferably results in a product containing 1,3-1,4 β D-glucan having an average molecular weight of at least 1,500,000 Daltons (for brevity, this will be termed high molecular weight glucan) in dissolved and/or suspended form. This has been found to improve the resistance of the probiotic microorganisms to degradation when passing through the highly acid portion of the gastrointestinal tract. It is believed that colloid-forming substances derived from the oats (including hydrated high molecular weight glucan) coat the cells of live probiotic bacteria. This provides protection to the bacteria as they pass through the GI tract to the large intestine. Additionally, the high molecular weight glucan is also a contact food for both the probiotic microorganisms and the natural microflora in the gut, and therefore promotes the growth of these microorganisms. It is believed that the combination of the hydrated high molecular weight glucan and the growth factors from the first fermentation step assists in maintaining the amount of each of Lactobacteria and Bifidobacteria at a level of 10E7 CFU/g or above for the shelf life of the product, which can be longer than 28 days. The product of the present invention may be a relatively stable colloid suspension. The presence of high molecular weight glucan in dissolved and/or suspended form is believed to contribute to the stability of the colloid suspension, and avoid early separation of the product into layers.

Lactobacteria are known to the skilled person. They are also sometimes termed

Lactic Acid Bacteria in the art. Lactobacteria include, but are not limited to, bacteria selected from one or more of the following genera: Lactobacillus, Leuconostoc, Pediococcus, Lactococcus, Streptococcus, Aerococcus, Carnobacterium, Enterococcus, Oenococcus, Teragenococcus, Vagococcus, and Weisella. The Lactobacteria is preferably selected from the genera Lactobacillus and/or Streptococcus. The Lactobaceria may be selected from one or more of Lactobacillus acidophilus, Lactobacillus rhamnosus, Lactobacillus plantarum, Lactobacillus paracasei, Lactobacillus casei, Streptococcus thermophilus, Lactobacillus bulgaricus, Streptococcus lactis, Streptococcus cremoris, Streptococcus diacetylactis, Lactococcus lactis, Lactococcus cremoris, Lactococcus diacetylactis, Lactobacillus helveticus, Lactobacillus lactis, Lactobacillus delbruekii, Propionibacterium spp, and Kluyveromyces lactis. In the present invention, the quantity of 10E7 CFU/g Lactobacteria refers to the total quantity of Lactobacteria in the aqueous suspension and/or the product of the present invention.

Bifidobacteria are known to the skilled person. Any bifidobacterium may be used in the present invention. The Bifidobacteria may be selected from one or more of the following species Bifidobacterium adolescentis, Bifidobacterium angulatum, Bifidobacterium animalis, Bifidobacterium asteroides, Bifidobacterium bifidum, Bifidobacterium boum, Bifidobacterium breve, Bifidobacterium catenulatum, Bifidobacterium choerinum, Bifidobacterium coryneforme, Bifidobacterium cuniculi, Bifidobacterium denticolens, Bifidobacterium dentium, Bifidobacterium gallicum, Bifidobacterium gallinarum, Bifidobacterium indicum, Bifidobacterium infantis, Bifidobacterium inopinatum, Bifidobacterium lactis, Bifidobacterium longum, Bifidobacterium magnum, Bifidobacterium merycicum, Bifidobacterium minimum, Bifidobacterium pseudocatenulatum, Bifidobacterium pseudolongum, Bifidobacterium pullorum, Bifidobacterium ruminantium, Bifidobacterium saeculare, Bifidobacterium subtile, Bifidobacterium suis, Bifidobacterium thermacidophilum and Bifidobacterium thermophilum. Preferably, the Bifidobacteria comprises one or more of Bifidobacterium animalis, Bifidobacterium breve, Bifidobacterium infantis, Bifidobacterium lactis, and Bifidobacterium longus. In the present invention, the quantity of 10E7 CFU/g Bifidobacteria refers to the total quantity of Bifidobacteria in the aqueous suspension and/or the product of the present invention.

Preferably, the second fermentation step involves the fermentation of the aqueous suspension in the presence of Lactobacteria and Bifidobacteria, until the quantity of each of Lactobacteria and Bifidobacteria is at least 10E7 CFU/g.

Preferably, the probiotic oat-based fluid food product comprises at least 10E7 CFU/g Lactobacteria and at least 10E7 CFU/g Bifidobacteria.

As mentioned above, the aqueous suspension and/or the product of the present invention preferably contains 1,3-1,4 β D Glucan having an average molecular weight of at least 1,500,000 Daltons. The average molecular weight of the 1,3-1,4 β D Glucan in the product is measured in accordance with the method described by Lena Rimsten et al in Cereal Chemistry 2003, Volume 80, Number 4: 485-490, entitled Determination of beta-Glucan Molecular Weight Using SEC with Calcofluor Detection in Cereal Extracts, which is incorporated herein by reference. In particular, the method of measuring the average molecular weight should include a hot-water extraction of the glucan from the product using thermostable α-amylase (the ‘third method’ of extraction in this document under the heading Extraction Methods in the second column of page 486); prior to the extraction, the sample should be boiled in water containing 50% (by volume) ethanol for 15 minutes to deactivate any β-glucanase present in the product (in accordance with the method described under the heading Endogenous Activity in Samples During and After Extraction on page 487, column 2 of this document). More preferably, the average molecular weight of 1,3-1,4 β D Glucan in the product is at least 2,000,000 Daltons.

Oat Material

“Oat based” indicates that the product is derived from and contains oat material.

An oat grain generally comprises four parts: an inedible hull, an outer layer of bran and the endosperm and the germ. Generally, oats are de-hulled (i.e. the hulls are removed) before the oats are processed for food production. Unless otherwise stated herein, “oat material” and “oat-derived substances” may include one or more of bran, endosperm and germ; hull will not generally be present.

The oat material in step A) can be any material containing oat derived substances that can undergo fermentation. Such oat material includes, but is not limited to, oatmeal and oat bran. The oat material may comprise de-hulled oat grains. Oatmeal and oat bran are common terms in the art. Oatmeal includes, but is not limited to, ground, crushed and/or rolled oat grains. In the present invention, oatmeal may also include dehulled oat kernels. The oat kernels are preferably sliced and/or ground using the slicing and/or grinding processes described herein. Oat bran includes, but is not limited to, the hard, outer layer of oat grain. The oat material may have been ground and/or sliced prior to the first fermentation step. The oat material may be in the form of an aqueous suspension of ground oat substances, such as oatmeal and/or oat bran.

Preferably, prior to the addition of any water, the oat material in step A (e.g. oatmeal and/or oat bran) and/or the one or more unfermented substances in step B (e.g. oatmeal and/or oat bran) contain at least 5% by weight (w/w) of 1,3-1,4 β D-glucan. The amount of 1,3-1,4 β D-glucan in the oat material is measured using the standard method of the American Association of Cereal Chemists (AACC), Method 32-23. The amount of 1,3-1,4 β D-glucan is to be measured on the basis of samples (e.g. of oatmeal or oat bran) that, unless otherwise stated, have not been dried to remove their moisture content. Unless otherwise stated herein, the amount of 1,3-1,4 β D-glucan in all components of the present invention, such as oat meal and oat bran, is measured in the same manner, i.e. on the basis of the amount of 1,3-1,4 β D-glucan in the relevant component using the AACC Method 32-23.

Preferably, the oats from which the oat material and the unfermented oat-derived substances are obtained contain at least 5 wt % of 1,3-1,4 β D-glucan. This has been found to be important in producing a product with desired minimum content of high molecular weight 1,3-1,4 β D-glucan in dissolved and/or suspended form.

### First Fermentation Step

The first fermentation step may be carried out in a manner known to those skilled in the art. It is typically carried out in water. The proportion of water to oat material and, if present, the malted cereal material, may be determined by the skilled person in a routine manner. Typically, the water may be present in the fermentation mixture in an amount of from 25 to 75 wt %. In the first fermentation step, the oat material is preferably fermented in the presence of malted cereal. In terms of the dry weights of the oat material and malted cereal, the proportion of oat material:malted cereal in the first fermentation step may be 1:10 to 10:1, preferably 1:1 to 1:10, more preferably 1:2 to 1:4, most preferably about 1:3. Malted cereals are known to those skilled in the art. A malted cereal is a cereal that has been allowed to germinate. The malted cereals may comprise malted oats and/or malted barley. Preferably, the malted cereals contain malted barley. The malted cereals used in the first fermentation step may be cereals that have been malted, i.e. allowed to germinate, and then ground and optionally further processed as necessary. The present inventors have found that malted cereals, particularly malted barley, surprisingly promote the fermentation processes in the present invention, as the malted oats contain easily assimilable proteins, carbohydrates, minerals and vitamins suitable for promoting the growth of microorganisms in the fermentation processes. The malting of the cereals is believed to weaken the intercellular bonds in the cereals, increase the permeability of the cell walls, produce simpler carbohydrates, treat the grains with natural enzymes and obtain bacterial growth factors (the easily assimilable proteins, carbohydrates, minerals and vitamins). The malted cereals can therefore act as a suitable substrate for the primary and secondary fermentation. The aqueous suspension formed in step B and/or the pro-biotic oat-based fluid food product of the present invention preferably contain from 1 to 10 wt % of malted cereal material, preferably of from 2 to 5 wt % malted cereal material.

The first fermentation step may involve fermentation in the presence of one or more microorganisms selected from lactobacteria, yeasts and other bacteria suitable for promoting and/or enabling the fermentation of oats. The first fermentation is preferably carried out in water. The weight ratio of solids: water in the fermentation step may be 1:1 to 1:4, preferably about 1:2 to 1:3, most preferably about 1:2.5 (a water content of about 71% and an a solids content of about 29%). Preferably substantially all of the “solids” of the solids content is derived from oats and, if present, malted cereal material.

The microorganisms may be selected from Lactobacillus plantarum, Leuconostoc mesenteroides, Pediococcus cerevisiae, Saccharomyces cerevisiae and Bacillus subtilis.

The first fermentation step may carried out in the presence of yeast.

The microorganisms that enable the first fermentation step to be carried out may be microorganisms naturally present in the oat material and/or malted cereal. There may be no need to inoculate the oat material with additional microorganisms for the fermentation process.

The first fermentation step may involve carrying out the fermentation in water until a viscosity of from 1000 to 20000 cP and/or a pH of 3.2 to 4.5 is reached.

The fermentation mixture will typically contain more than 40% by weight of water. Accordingly, following the first fermentation, the fermentation mixture may be dried, e.g. using evaporation, to a water content of 40 wt % or less (i.e. a solids content of 60 wt % or more), preferably a water content of 30 to 35% optionally following by grinding and/or slicing of the oat and other cereal particles, as described herein, to form the products of the first fermentation step.

Malting Step

As mentioned above, in the first fermentation step, the oat material is preferably fermented in the presence of malted cereal, most preferably barley. The process of the present invention may further involve, prior to the first fermentation step, the production of malted cereal grains by the malting of cereal grains. The malting of cereal grains is well known to the skilled person and any suitable method may be employed in the present invention.

The malting of the cereal grains may be carried out by steeping the cereal grains in water at a temperature of from 10 to 16° C., germination at a temperature from 13 to 16° C. for 3-4 days, drying the resultant mixture to a water content of 10 wt % and then optionally processing the grains, for example by hulling, polishing, sifting and grinding the grains.

Aqueous Suspension

The aqueous suspension formed in step (B) may be a colloidal suspension. A colloidal suspension includes, but is not limited to, a stable dispersion of particles in a liquid. The particles may be liquid and/or solid particles. The particles in the suspension may have a diameter of 500 μm or less, preferably 100 μm or less, more preferably 80 μm or less, most preferably 60 μm or less. Preferably at least 90% by weight of the particles, more preferably at least 95% of the particles have diameters of 500 μm or less, preferably 100 μm or less, more preferably 80 μm or less, most preferably 60 μm or less.

The oat material (either before or after step A) and/or malted cereal material (either before or after step A) and/or the one or more oat-derived substances (in step B) may be subjected to mechanical treatment such as grinding and/or slicing to reduce their particle size, preferably so that at least 90% by weight (more preferably at least 95% by weight, most preferably at least 98% by weight) of the particles have a maximum diameter of 500 μm, preferably a maximum diameter of 100 μm or less, preferably a maximum diameter of 80 μm or less. The maximum diameter may be of from 30 to 80 μm. The slicing of the oat material and/or cereal material and/or the unfermented oat-derived substances may be achieved using a slicing machine that slices using a number of blades, which move together to slice the oat particles. The slicing process is most suitably carried out by mixing the oat material and/or cereal material and/or the unfermented oat-derived substances with water and passing them through the slicing machine. Such slicing machines are commercially available. A suitable machine (model ARV-1000) is available from Thechnologichesky cetr “Sistema”, INN 2309064155, 350063, Krasnodar, St. Mira, b.28, Russia. In the slicing machine, the oat material may be sliced in the water in a slicing chamber, by the repeated moving together of opposed blades, and then water and oats are forced through a sieve to allow only particles of a desired size through the sieve. The oat and/or cereal particles are preferably subjected to the slicing process for a period of from 1 to 20 minutes, more preferably from 5 to 15 minutes, most preferably from 7 to 10 minutes, preferably at a temperature of from 18 to 20° C. The slicing process has found to be effective as it shears the oat particles, breaking at least some of the intercellular bonds and/or the cells of the oat material, which allows for the facile extraction of the 1,3-1,4 β D-glucan from the material into water.

It has been found that grinding of oat bran is most suitable in the present invention for the successful extraction of the high molecular weight β D glucan and formation of a product, ideally a colloid, of suitable consistency and stability. The grinding may be by any suitable method, but is preferably wet grinding using suitable means, such as a colloid mill.

It has been found that the particles of oatmeal are most suitably reduced in size using a slicing method, which preferably involves slicing the particles in water using suitable means. Such slicing means may include an automated slicing machine, as described above.

The aqueous suspension formed in step (B) preferably has a viscosity of from 1000 to 10 000 cP.

The mechanical treatment to form the aqueous suspension may comprise steeping the one or more unfermented oat-derived substances in water at a temperature of less than 68° C. to extract 1,3-1,4 β D-glucan from the oat-derived substances. The one or more unfermented oat-derived substances may be steeped in water for a period of at least 5 minutes, preferably up to 60 minutes, more preferably 20 to 30 minutes. The mechanical treatment may involve grinding and/or slicing the one or more unfermented oat-derived substances to reduce their particle size, which may be before, during or after steeping the oat-derived substances in water. The mechanical treatment may involve grinding and/or slicing the one or more unfermented oat-derived substances in water at a temperature of less than 68° C. The products from the first fermentation step may also be ground and/or sliced prior to combination with the one or more unfermented oat-derived substances. Alternatively, the products of the first fermentation step may be ground and/or sliced together with the one or more unfermented oat-derived substances. The mechanical treatment may involve, while grinding/slicing and/or steeping the one or more unfermented oat-derived substances in water, subjecting the one or more unfermented oat-derived substances to ultrasonic radiation. The ultrasonic treatment may be carried out for a period of from 5 to 20 minutes. The ultrasonic treatment assists in extracting the high molecular weight glucan from the oat materials and allowing it to dissolve and/or form a stable suspension. A suitable ultrasonic treatment may, for example, using an ultrasonic generator operating at a wattage of 3000 to 10000 W, preferably about 7000 to 9000 W. Ideally, it should be able to process liquid at a rate of 100 L per minute or more. The intensity of the ultrasound may be in the range of from 5 to 20 W/cm², preferably of from 10 to 15 W/cm², more preferably about 13 to 14 W/cm², most preferably about 13.4 W/cm². The intensity of the ultrasound may be at least 13.4 W/cm².

The present inventors have found that by steeping oat material (e.g. the oat material of step A, and/or the one or more unfermented oat-derived substances of step B) in water at a temperature less than 68° C. one is able to extract high molecular weight 1,3-1,4 β D-glucan from the oat materials more easily and in greater quantities than the processes of the prior art. Steeping at this temperature avoids dextrinization of the starch before at least some of the high molecular weight 1,3-1,4 β D-glucan has been effectively extracted. By first extracting the glucan below 68° C., one can then subject the oats to an extraction at a temperature of more than 68° C. A particularly effective process in extracting the high molecular weight 1,3-1,4 β D-glucan is to subject the one or more unfermented oat-derived substances to a first steeping in water at a relatively low temperature (e.g. 25° C. or less), then grinding and/or slicing the oat-derived substances, followed by a second steeping in the water, which may be above the temperature of the first steeping, while preferably subjecting the oat-derived substances to an ultrasonic treatment. The temperature of the water in the second steeping may be raised gradually to a temperature at or just below the dextrinization of starch (68° C.) to optimize the amount of glucan extracted.

The unfermented oat-derived substances may comprise oatmeal and/or oat bran. The unfermented oat-derived substances may comprise de-hulled oat kernels. The aqueous suspension may contain ground and/or sliced oatmeal and/or ground and/or sliced oat bran. Preferably, the unfermented oat-derived substances comprise oatmeal and oat bran. In terms of the dry weights of oatmeal and oat bran, the aqueous suspension in step B may contain proportions of oatmeal:oat bran of from 1:10 to 10:1, preferably 1:5 to 5:1, more preferably 2:1 to 1:2, more preferably of from 1:1 to 1:2. In the present invention, if a component is stated to contain a proportion of oatmeal: oat bran, this indicates the proportions of oatmeal and oat bran from which the component is derived. Preferably the unfermented oat-derived substances contain, prior to the addition of water in step B, at least 5 wt % (w/w) of 1,3-1,4 β D-glucan. The unfermented oat-derived substances may comprise oat bran that, prior to the addition of water in step B, contains at least 10 wt % (w/w) of 1,3-1,4 β D-glucan.

The aqueous suspension and/or the pro-biotic oat-based fluid food product may contain of from 1 to 20% by weight of oat bran material, i.e. material derived from oat bran, preferably of from 2 to 10% by weight of oat bran material, most preferably of from 2.5 to 4% by weight of oat bran material. The aqueous suspension and/or the pro-biotic oat-based fluid food product may contain of from 1 to 20% by weight of oatmeal material, i.e. material derived from oatmeal, preferably of from 2 to 10% by weight of oat meal material, most preferably of from 2.5 to 4% by weight. The aqueous suspension and/or the pro-biotic oat-based fluid food product preferably contains 4 to 40% by weight of solids material, preferably all or substantially all of which is derived from fermented and/or unfermented oat-derived substances (which includes oat bran and/or oatmeal). The aqueous suspension and/or the pro-biotic oat-based fluid food product preferably contains of from 1 to 20% by weight of oat bran material, preferably of from 2 to 10% by weight of oat bran material, most preferably of from 2.5 to 4% by weight (this amount of oat bran being measured in terms of solids content), with the remainder of the solids material being or being derived from oatmeal.

The mechanical treatment of step B preferably comprises steeping the one or more unfermented oat-derived substances in water at a temperature of less than 68° C. to extract 1,3-1,4 β D-glucan from the oat-derived substances; , wherein the one or more unfermented oat-derived substances are ground or sliced before, during or after the steeping.

As mentioned above, the products from the first fermentation step are preferably combined with the one or more oat-derived substances and the water, before, during or after the formation of the aqueous suspension. Preferably, the products from the first fermentation step are combined with the one or more oat-derived substances and the water after the formation of the aqueous suspension, and before the second fermentation.

The mechanical treatment preferably comprises steeping the one or more unfermented oat-derived substances in water at a temperature T1, which is less than 68° C., preferably for a period of from 10 to 50 minutes (more preferably 20 to 35 minutes), to extract 1,3-1,4 β D-glucan from the oat-derived substances, followed by steeping the one or more oat-derived substances in the water at a temperature T2, which is more than T1, preferably for a period of from 10 to 50 minutes (more preferably 20 to 35 minutes), slicing and/or grinding the one or more unfermented oat-derived substances before, during and/or after the steeping at T1 and/or T2, and then combining the resultant mixture with the products from the first fermentation step.

The one or more unfermented oat-derived substances may be sliced and/or ground in the water following the steeping at temperature T1 and before the steeping at temperature T2, preferably such that at least 90% by weight of the particles of the oat-derived substances have a maximum diameter of 100 μm or less.

The mechanical treatment preferably comprises steeping oat bran in water at a temperature T1, which is less than 68° C., preferably for a period of from 10 to 50 minutes (more preferably 20 to 35 minutes), to extract 1,3-1,4 β D-glucan from the oat bran, followed by steeping the oat bran in the water at a temperature T2, which is more than T1, preferably for a period of from 10 to 50 minutes (more preferably 20 to 35 minutes), grinding the oat bran before, during and/or after the steeping at T1 and/or T2, and then combining the resultant mixture with the products from the first fermentation step. Preferably, the oat bran is ground in the water following the steeping at temperature T1 and before the steeping at temperature T2. T1 may be 15° C. or less. T2 is preferably less than 68° C., and may be from 20 to 50° C. The mechanical treatment may involve, while grinding and/or steeping the oat bran in water, subjecting the oat bran to ultrasonic radiation. The ultrasonic treatment may be carried out for a period of from 5 to 20 minutes.

Preferably, the one or more unfermented oat-derived substances comprise oat bran containing at least 10 wt % of 1,3-1,4 β D-glucan. Preferably, the oat bran containing at least 10 wt % of 1,3-1,4 β D-glucan is steeped in water with simultaneous grinding at a temperature T1 of 25° C. or less, and then steeped in the water at a temperature T2, which may be higher than T1 and 68° C. or lower to form an aqueous suspension of ground oat bran. T1 is preferably 25° C. or less, preferably 15 to 20° C. Most preferably, the oat bran is steeped in water at a temperature of 25° C. or less without grinding for 10 to 50 minutes, preferably from 20 to 35 minutes, then subjected to grinding in the water at a temperature of 25° C. or less for a period of about 5 to 15 minutes, followed by further steeping the oat bran in water without grinding, at a temperature T2 of 25° C. or less for a further 5 to 15 minutes. The oat bran may be subjected to a further steeping at a temperature T3, which is higher than T2, which is preferably of from 20 to 50° C., preferably at a temperature of from 40 to 50° C., preferably for a period of from 5 to 15 minutes. The temperature of the oat bran and the water may be raised from temperature T2 gradually over a period of from 5 to 15 minutes to temperature T3.

The aqueous suspension formed in step B may be subjected to one or more heating, extraction, particle-size reduction (e.g. grinding and/or slicing) and solubilisation (e.g. ultrasonic) processes. Preferably at least some of the components of the suspension have undergone an extraction in water (which may include steeping in water, optionally with simultaneous grinding and/or slicing) at a temperature of less than 68° C., more preferably at a temperature of less than 30° C., before the aqueous suspension is subjected to a heating process at a temperature of 68° C. or more. The aqueous suspension may be heated to a temperature of 68° C. or more, preferably of from 68° C. to 78° C., preferably for a period of at least 5 minutes, more preferably for 5 to 30 minutes, more preferably about 8 to 16 minutes, most preferably about 12 minutes. This has been found to effectively extract a substantial amount of high molecular weight 1,3-1,4 β D-glucan from the oat-derived substances, such as oat bran and oatmeal.

Preferably, the unfermented oat-derived substance comprises oatmeal containing at least 5 wt % of 1,3-1,4 β D-glucan. Preferably, the oatmeal containing at least 5 wt % of 1,3-1,4 β D-glucan is steeped in water at a temperature T1, which is less than 68° C., then ground in the water, and then steeped in the water at a temperature T2, which may be more than T1, to form an aqueous suspension of ground oatmeal. T1 may be 15 to 20° C. and T2 may be 18 to 20° C., and, between the extractions, the oats may be reduced in size by a slicing method, as described herein. T1 may be 15° C. or less and T2 may be 100° C. or more.

The aqueous suspension of ground oat bran may be combined with the aqueous suspension of ground and/or sliced oatmeal and, optionally, the products of the first fermentation step to form the aqueous suspension in step B. Alternatively, the aqueous suspension of ground oat bran may be combined with the aqueous suspension of ground and/or sliced oatmeal to form the aqueous suspension in step B;

the products of the first fermentation step may be added after formation of the aqueous suspension in step B and, optionally, before addition of the products of the first fermentation step, the aqueous suspension may be subjected to one or both of the following:
(i) a heating process at a temperature of 30° C. or more, more preferably at a temperature of from 40 to 80° C. This temperature may be above or below 68° C. A temperature of about 68° C. or more (preferably a temperature of from 65 to 78° C.) has been found to be most suitable for a making a final product with a relatively low viscosity, such as a drinkable product. A temperature of less than 68° C. (preferably a temperature of from 50 to 60° C.) has been found to be most suitable for a making a final product with a relatively high viscosity, such as a ‘spoonable’ product, with a consistency similar to yoghurt. This heating process is preferably carried out for a period of from 5 to 30 minutes, preferably from 8 to 16 minutes, preferably about 12 minutes;
(ii) a centrifugation process, preferably at a temperature above 60° C., more preferably at a temperature at or above 68° C., preferably of from 68 to 70° C.; preferably at 1500 to 3000 RPM, preferably using a centrifuge with sieves having apertures having cross sectional areas of 5 mm² or less, more preferably having a cross sectional areas of 3 mm² or less, most preferably a cross sectional area of 1 mm² or less. The centrifuge may have apertures having cross sectional areas of 0.64 mm² or less (they may be square apertures having dimensions of 0.8 mm×0.8 mm). The centrifugation is preferably carried out for a period of from 1 to 30 minutes, or as long as required to separate the undesired (large) particles from the aqueous suspension, preferably such that the suspension is substantially free of particles having a diameter of 3 mm or more, preferably 1 mm or more. “Substantially free” in this context includes, but is not limited to, a suspension containing less than 5 wt %, preferably less than 2 wt %, of particles having a diameter of 3 mm or more, preferably 1 mm or more.

The aqueous suspension formed in step B may be subjected to a sterilization process before step C. Preferably, the aqueous suspension of ground oat bran may be combined with the aqueous suspension of ground and/or sliced oatmeal to form the aqueous suspension in step B, the aqueous suspension is then subjected to a heating process as described in (i) above, and then a centrifugation process as described in (ii) above; the products from the first fermentation step are then added to the suspension, and the resulting mixture subjected to a sterilization process. The sterilization process may be a process that involves heating the suspension at a temperature above 70° C. The sterilization process may be a process that involves heating the suspension at a temperature at or above 100° C. The sterilization process may be carried out for a period of 20 minutes or more, preferably from 30 to 40 minutes.

Prior to combination with the one or more unfermented oat-derived substances, the products from the first fermentation step may be subjected to a grinding process and/or a slicing process in water to form an aqueous suspension X. The aqueous suspension of ground oat bran and the aqueous suspension of ground oatmeal may be mixed, and then centrifuged at a temperature of more than 65° C., preferably 65-78° C., to form the aqueous suspension in step B, which is preferably substantially free of particles having a diameter of 3 mm or more, preferably 1 mm or more. “Substantially free” in this context includes, but is not limited to, a suspension containing less than 5 wt %, preferably less than 2 wt %, of particles having a diameter of 3 mm or more, preferably 1 mm or more. The aqueous suspension X may be combined with the aqueous suspension of ground oat bran and the ground and/or sliced oatmeal before or after the centrifugation process.

The process may further involve heating the centrifuged suspension at a temperature above 68° C. for a period of at least 20 minutes, preferably 30 to 40 minutes. The temperature may be 100° C. or more, preferably 70 to 100° C.

The oat material and/or the one or more unfermented oat-derived substances may comprises heat-treated oatmeal, which may comprise heat-treated whole oat kernels. The oatmeal has preferably been heat-treated by subjecting it to a steam treatment at a temperature of 100° C. or more. The heat treatment should be carried out before the oatmeal is steeped in water. The heat treatment may be carried out until the degree of starch gelatinization (DSG) in the oat material is 90% or more, and may be 95% or more or about 100%; this has been found to be most suitable for producing a product of relatively low viscosity. Alternatively, the oat material may be heated until the DSG is 30 to 70%, more preferably 40 to 60%, most preferably about 50%; this has been found to be most suitable for producing a product with relatively high viscosity.

The steam treatment may be carried out at a pressure of 2 atm or more, preferably at about 2.5 atm, preferably for a period of at least 15 minutes, more preferably for at least 30 minutes and for less than 60 minutes, most preferably for a period of about 45 minutes.

The mechanical treatment may comprise steeping heat-treated oats containing at least 5 wt % (w/w) 1,3-1,4 β D-glucan (before the heat-treatment) in water at a temperature T1 not exceeding 15° C., then grinding and/or slicing the heated treated oats in water, followed by a heat treatment at a temperature T2 of more than 100° C.

The aqueous suspension formed in step B preferably has a water content of from 2.5 to 20 wt %. Water may be added or removed to bring the suspension within these preferred limits of water content using known techniques.

Second Fermentation Step

Following step B, the aqueous suspension may be subjected to sterilization, preferably a thermal sterilization, then preferably cooled to a temperature below 43° C., inoculated with Lactobacteria and/or Bifidobacteria and then subjected to the secondary fermentation of step C). The thermal sterilization may be carried out at a temperature of more than 70° C. and optionally up to 150° C., preferably 135° C. or less. The thermal sterilization may be carried out at a temperature of from 70 to 100° C. If the sterilization is carried out at a temperature of from 120° C. or above, the sterilization may be carried out for a relatively short period of time, e.g. for a period of up to about 2 minutes, optionally of from about 45 to 60 seconds. If the sterilization is carried out at a lower temperature, the sterilization should be carried out for longer. For example, if the sterilization is carried out at a temperature of from 70 to 100° C., it preferably is carried out for 20 minutes or more, preferably for 30 to 40 minutes.

Final Steps

Following the second fermentation, the product, i.e. the resultant suspension, may be cooled to a temperature of from 10° C. or less. One or more edible fillers may be added to the suspension. Such fillers are known to the skilled person.

Following the second fermentation, the product may be cooled to a temperature of from 2 to 6° C.

Following the second fermentation and optionally the cooling of the suspension, fruits may be added to the suspension, the suspension then packaged in an air-tight container and kept at a temperature of 6° C. or less, preferably 2 to 4° C., for a period of between 12 to 72 hours, preferably 24 to 48 hours.

Preferably, the viscosity of the product formed in the process of the present invention is between 2000 to 80000 cP. The viscosity may be from 20000 to 80000 cP, which is suitable for a yogurt-like consistency, i.e. a relatively viscous product that be eaten with a spoon.

Preferably, the viscosity of the final suspension is between 2000 to 50000 cP, which is suitable for a drinkable product.

The Oat-Based Product

The present invention further provides a probiotic oat-based fluid food product comprising
a. 1,3-1,4 β D-glucan, wherein preferably the average molecular weight of the 1,3-1,4 β D-glucan in the product is at least 1 500 000 Daltons;
b. 2.5 to 40 wt % solids, at least some of which is derived from oats;
c. at least 10E7 CFU/g Lactobacteria and/or at least 10E7 CFU/g Bifidobacteria
d. with the remainder water.

The 1,3-1,4 β D-glucan is preferably in dissolved and/or suspended form. The product preferably contains at least 0.4 wt % of β D-glucan, which has been found to be a suitable amount for the glucan to have the beneficial effects described herein. The 2.5 to 40 wt % of solids includes 1,3-1,4 β D-glucan.

The product preferably has a glycaemic index of from 40 to 60 units.

The product preferably has a pH of from 3.2 to 4.5

The product preferably has a viscosity of from 2000 to 80 000 cP

The product preferably has a calorific value of from 20 to 90 kcal/100 g.

The product is preferably obtainable from the process of the present invention.

The present invention further provides a probiotic oat-based fluid food product comprising:
a. at least 0.4 wt % 1,3-1,4 β D-glucan;
b. 2.5 to 40 wt % solids, at least some of which is derived from oats;
c. at least 10E7 CFU/g Lactobacteria and/or at least 10E7 CFU/g Bifidobacteria
d. with the remainder water.
e.
   The average molecular weight of the 1,3-1,4 β D-glucan in the product is preferably at least 1,500,000 Daltons, and obtainable by the method of the present invention.

Two-Step Process

The present invention further provides a process for preparing a pro-biotic oat-based fluid food product, the process comprising:
A) mechanically treating one or more unfermented oat-derived substances in the presence of water to form an aqueous suspension containing 1,3-1,4 β D-glucan, preferably having an average molecular weight of at least 1,500,000 Daltons, in dissolved and/or suspended form, and combining fermented oat material with the one or more oat-derived substances and the water, before, during or after the formation of the aqueous suspension; and
B) a second fermentation step, involving the fermentation of the aqueous suspension in the presence of Lactobacteria and/or Bifidobacteria, until the quantity of Lactobacteria is at least 10E7 CFU/g and/or the quantity of Bifidobacteria is at least 10E7 CFU/g.

The fermented oat material may have been prepared as described above. All other aspects of the process may be as described above.

In a first preferred embodiment the present invention provides a bio-oat food product which is obtained by processing oats and derivatives thereof, the bio-oat food product having a glycaemic index from 40 to 60 units, pH from 3.2 to 4.5, viscosity from 20 000 to 80 000 cP, calorific value from 20 to 90 kcal/100 g and characterized by the following contents of the main components:

| | |
|---|---|
| High-molecular 1,3-1,4 β D-glucan | 0.4-0.8 wt. % |
| Dry matter | 6.0-40.0 wt. % |
| Lactobacteria | at least 10E7 CFU/g |
| Bifidobacteria | at least 10E7 CFU/g |
| Remainder | water |

The following components are used as oats and oat derivatives in the bio-oat food product: coarse-ground oatmeal component, malted oats component, raw oats component and oat bran component, as defined below.

The bio-oat product contains at least 0.4 wt.% of high-molecular 1,3-1,4 β D-glucan, extracted during processing of oat bran, hydrated and stabilized with formation of a colloidal solution, coarse-ground oatmeal and malted oats, after primary fermentation by a mixture comprising lactobacteria, yeasts and bacteria, with addition of raw oats, the coarse-ground oatmeal component, malted oats component, raw oats component and the oat bran component being used in the proportions 1:1:5:7 (including the components' water content), followed by further addition of water to give content of dry matter (i.e. solids content) from 6.0 to 40.0 wt. %, the mixture obtained undergoing secondary fermentation by probiotic bacteria, the amount of which by the end of the shelf life of the product is at least 10E7 CFU/1 g. In this embodiment, high molecular weight 1,3-1,4 β D-glucan includes 1,3-1,4 β D-glucan having a molecular weight of 2,000,000 Daltons or more.

In the bio-oat food product, the raw oats component, which is characterized by content of edible vegetable oat fibres 1,3-1,4 β D-glucan of at least 5 wt %, may formed from oat grains by removal of impurities, hulling, polishing, steaming, rolling, drying, steeping in water at a temperature not above 15° C. and with ratio of oats to water of 1:1.5, followed by dispersion and heat treatment at a temperature above 100° C.

In the bio-oat food product, the oat bran component, which is characterized by content of edible vegetable oat fibres of 1,3-1,4 β D-glucan of at least 10 wt %, may be processed by dissolution in water at ratio of oat bran to water of 1:1.5, cold extraction with simultaneous dispersion followed by thermal extraction of the edible vegetable oat fibres in the temperature range from 15° C. to the temperature of dextrinization of oat starch, to achieve pH from 5.9 to 6.2 and viscosity from 5000 to 35 000 cP.

In the bio-oat food product, the malted oats component, which is characterized by content of edible vegetable oat fibres of 1,3-1,4 β D-glucan of at least 5 wt %, may be obtained by steeping raw oats in water at a temperature from 10 to 16° C., germination at a temperature from 13 to 16° C. for 3-4 days, drying to water content of 10% and is then processed by hulling, polishing, sifting, and grinding for further mixing with thermized (heat-treated) coarse-ground oatmeal.

In the bio-oat food product, the coarse-ground oatmeal component, which is characterized by content of edible vegetable oat fibres of 1,3-1,4 β D-glucan of at least 5 wt %, is submitted to heat treatment, after which it is mixed with ground malted oats in the proportions 1:3, the mixture obtained is diluted with water in the ratio 1:2.5, after which the aqueous mixture is inoculated with microorganisms: Lactobacillus plantarum, Leuconostoc mesenteroides, Pediococcus cerevisiae, Saccharomyces cerevisiae and Bacillus subtilis, with primary fermentation to mixture viscosity from 2000 to 20 000 cP, pH from 3.2 to 4.5, and undergoes thermal drying to water content 6%, followed by grinding.

In the bio-oat food product, the processed components—coarse-ground oatmeal, malted oats, raw oats and oat bran—are used in the proportions 1:1:5:7 (by weight and including the water content of all components), followed by the addition of water to give dry matter content from 6.0 to 40.0 wt. %, then homogenized, submitted to thermal sterilization, cooled to a temperature not above 43° C., inoculated with probiotic bacteria, submitted to secondary fermentation, and then cooled to a temperature from +2 to +6° C., viscosity from 20 000 to 80 000 cP and, preferably, to viscosity from 20 000 to 60 000 cP.

The bio-oat food product may additionally contain an edible filler.

The bio-oat food product may additionally contain one or more of the following vitamins, preferably in the amounts shown: E, from 0.1 to 0.6 mg/100 g; D, from 0.1 to 0.4 μg/100 g; B1, from 0.01 to 0.1 mg/100 g; B2, from 0.05 to 0.15 mg/100 g; PP, from 0.05 to 0.15 mg/100 g; folic acid, from 0.1 to 3.0 pg/100 g; and minerals: iron, from 0.5 to 1.5 mg/100 g; zinc, from 0.2 to 0.4 mg/100 g; iodine, from 0.1 to 0.4 mg/100 g.

It should be emphasized that during development of the proposed bio-oat food product, containing at least 0.4 wt. % 1,3-1,4 β D-glucan, it was established that the following stages are important.

Preparation of oat raw material and derivatives thereof for industrial production of the product, using: oat bran, characterized by content of edible vegetable oat fibres of 1,3-1,4 β D-glucan of at least 10 wt %, coarse-ground oatmeal, characterized by content of 1,3-1,4 β D-glucan of at least 5 wt %, raw oats, characterized by content of edible vegetable oat fibres of 1,3-1,4 β D-glucan of at least 5 wt %; malted oats, characterized by content of edible vegetable oat fibres of 1,3-1,4 β D-glucan of at least 5 wt %, which is obtained by germination of raw oats, which makes it possible to weaken the intercellular bonds, increase the permeability of the cell walls, obtain simpler carbohydrates, treat the grains with natural enzymes and obtain bacterial growth factors—easily assimilable proteins, carbohydrates, minerals, vitamins, and thus obtain a raw material as substrate for primary fermentation.

The primary fermentation is preferably carried out using the following mixture as bioculture: lactic acid bacteria—Lactobacillus plantarum and Leuconostoc mesenteroides, yeasts—Pediococcus cerevisiae, Saccharomyces cerevisiae and bacteria—Bacillus subtilis. This produces a dry intermediate that is rich in growth factors for the secondary fermentation bacteria. It should be pointed out that the bioculture used for primary fermentation contains all the significant cultures, and the symbiotic effect of “co-existence” of these cultures and the qualitative composition of the metabolites (the products of their activity) were achieved during experimental studies. The aqueous mixture obtained is inoculated with the prepared culture. Primary fermentation is preferably carried out using a stock culture.

The process for producing a colloidal suspension (for subsequent secondary fermentation thereof using probiotic bacteria), results in a disruption of the intercellular bonds and walls of the cellular structures of the oat raw materials for maximum extraction, dissolution, hydration of edible fibres and adjustment of the colloidal suspension to the specified viscosity from 1000 to 10 000 cP. The molecules of 1,3-1,4 β D-glucan in the final suspension, which, as prebiotic, are not fermented in the stomach and in the upper compartments of the GI tract, but in the colon they exert a synergistic action on the pathogenic microflora and, being also food for useful microorganisms, which in its turn normalizes the metabolism, functions of the GI tract, pancreas, eliminates intestinal dysbacteriosis, improves the body's immune system and thus is effective for prophylaxis of a number of diseases.

Carrying out of secondary fermentation using probiotic bacteria, which are selected from known probiotic cultures for obtaining a symbiotic effect of the finished product, as a result of which there is accumulation of metabolites and live bacteria, which remain alive up to the end of product shelf life in an amount of 10E7 CFU in 1 g and endow the product with the useful properties of probiotics.

The growth of the bacteria used for secondary fermentation is aided by the presence of natural easily-assimilated nutrients and metabolites from the primary fermentation. It is important to note that in the proposed product all the nutrients for the activity of the microorganisms and the final nutrients are obtained by a natural biotechnological process, furthermore no artificially added growth factors need to be used.

Moreover, the culture containing the probiotic bacteria is used not only for direct enrichment of the product with probiotic cultures, thus endowing the product with properties that are beneficial to health, but also directly for the process of fermentation of the basis received in this stage of production for converting the nutrients to an easily assimilable form, development of adult probiotic bacteria, capable of maintaining their activity up to the end of the shelf life, and for endowing the product with organoleptic properties: the mild acid-sweet taste of a fermented oat product.

The homogeneous suspension obtained is submitted to thermal sterilization in a continuous tubular heat exchanger, heating to a temperature of 135° C., holding at this temperature for 45-60 s and then cooling to a temperature not above 43° C.

For carrying out secondary fermentation, a starter of known probiotic cultures is prepared. The mixture is inoculated with the prepared starter of probiotic cultures for carrying out secondary fermentation.

The proposed bio-oat food product, based on a content of high-molecular soluble edible oat fibres of 1,3-1,4 β D-glucan that is standardized (at least 0.4 wt. %) during industrial production, together with metabolites from primary fermentation, live probiotic bacteria and their metabolites from the second stage fermentation, possess properties that are beneficial to human health. Moreover, the bioavailable colloidal form of 1,3-1,4 β D-glucan in the finished product endows it with a functional role that has been demonstrated in clinical trials.

Industrial manufacture of the product is carried out using methods by which it is possible to select raw material with the qualitative and quantitative characteristics of soluble edible oat fibres, extract them efficiently from the cell walls of oat bran and from the adjacent outer layers of the oat grains, transfer them to a colloidal solution for imparting standardized viscosity, combine in the product with live bacteria by two-stage fermentation and provide directed prophylactic action of the finished product on human health.

The metabolites of primary fermentation, bioavailable molecules of 1,3-1,4 β D-glucan and the live probiotic cultures of the secondary fermentation promote restoration of the microflora after any manifestations of dysbacteriosis, improvement of colonization resistance of the gut, improvement of the assimilation of simpler nutrients and increase in the body's immune reactions.

Owing to the sufficiently low calorific value and standardized amount of 1,3-1,4 β D-glucan, the product has a glycaemic index of 40-50 units, which is actively used in a modern diet for prophylaxis of diabetes, weight control, and reduction of cholesterol level.

The proposed bio-oat food product, containing a standardized amount of 1,3-1,4 β D-glucan, was obtained by selecting the raw material and deep processing thereof, comprising two-stage fermentation, by two starter cultures, of oats and its derivatives and the use, in the primary fermentation, of yeasts, bacteria and lactocultures, with increase in efficiency of secondary fermentation by probiotic cultures on account of the metabolites from the primary fermentation and ultimately increase in the nutritional value of the finished product.

In a second preferred embodiment, the present invention provides a bio-oat drinkable food product which is obtained by processing oats and derivatives thereof, having a glycaemic index from 40 to 50 units, pH from 3.2 to 4.5, viscosity from 2000 to 50 000 cP, calorific value from 20 to 40 kcal/100 g and characterized by the following contents of the main components:

| | |
|---|---|
| High-molecular 1,3-1,4 β D-glucan | 0.4-2.0 wt. % |
| Dry matter | 2.5-20.0 wt. % |
| Lactobacteria | at least 10E7 CFU/g |
| Bifidobacteria | at least 10E7 CFU/g |
| Remainder | water |

The following components are used as oats and oat derivatives in the bio-oat drinkable food product: coarse-ground oatmeal component, malted oats component, raw oats component and oat bran component, as defined below.

The bio-oat drinkable food product contains at least 0.4 wt. % of high-molecular 1,3-1,4 β D-glucan, extracted during processing of oat bran, hydrated and stabilized with formation of a colloidal solution, coarse-ground oatmeal and malted oats, after primary fermentation by a mixture comprising lactobacteria, yeasts and bacteria, with addition of raw oats, the coarse-ground oatmeal component, malted oats component, raw oats component and oat bran component being used in the proportions 1:3:11:15 (including the components' water content), followed by further addition of water to give content of dry matter from 2.5 to 20.0 wt. %, the mixture obtained undergoing secondary fermentation by probiotic bacteria, the amount of which by the end of the shelf life of the product is at least 10E7 CFU/1 g. In this embodiment, high molecular weight 1,3-1,4 β D-glucan includes 1,3-1,4 β D-glucan having a molecular weight of 2,000,000 Daltons or more.

In the bio-oat drinkable food product, the raw oats component is preferably as defined above for the first preferred embodiment.

In the bio-oat drinkable food product, the malted oats component is preferably as defined above for the first preferred embodiment.

In the bio-oat drinkable food product, the oat bran component is preferably as defined above for the first preferred embodiment.

In the bio-oat drinkable food product, the coarse-ground oatmeal component is preferably as defined above for the first preferred embodiment.

In the bio-oat drinkable food product, the processed components—coarse-ground oatmeal, malted oats, raw oats and oat bran—are used in the proportions 1:3:11:15 (by weight and including the water content of all components), followed by the addition of water to give dry matter content from 2.5 to 20.0 wt. %, then homogenized, submitted to thermal sterilization, cooled to a temperature not above 43° C., inoculated with probiotic bacteria, submitted to secondary fermentation, and then cooled to a temperature from +2 to +6° C., viscosity from 2000 to 50 000 cP and, preferably, to viscosity from 2000 to 40 000 cP.

The bio-oat drinkable food product may additionally contain an edible filler.

The bio-oat drinkable food product may additionally contain one or vitamins as defined above for the first preferred embodiment.

Carrying out of the process for production of a colloidal suspension (for subsequent secondary fermentation thereof using probiotic bacteria), as a result of which there is disruption of the intercellular bonds and walls of the cellular structures of the oat raw materials for maximum extraction, dissolution, hydration of edible fibres and adjustment of the colloidal suspension to the specified viscosity from 1000 to 20 000 cP. The molecules of 1,3-1,4 β D-glucan in the final suspension, which, as prebiotic, are not fermented in the stomach and in the upper compartments of the GI tract, but in the colon they exert a synergistic action on the pathogenic microflora and, being also food for useful microorganisms, which in its turn normalizes the metabolism, functions of the GI tract, pancreas, eliminates intestinal dysbacteriosis, improves the body's immune system and thus is effective for prophylaxis of a number of diseases.

The homogeneous suspension obtained is submitted to thermal sterilization in a continuous tubular heat exchanger, heating to a temperature of 135° C., holding at this temperature for 45-60 s and then cooling to a temperature not above 43° C.

For carrying out secondary fermentation, a starter of known probiotic cultures is prepared. The mixture is inoculated with the prepared starter of probiotic cultures for carrying out secondary fermentation.

The proposed bio-oat drinkable food product, based on a content of high-molecular soluble edible oat fibres of 1,3-1,4 β D-glucan that is standardized (at least 0.4 wt. %) during industrial production, together with metabolites from primary fermentation, live probiotic bacteria and their metabolites from the second stage fermentation, possess properties that are beneficial to human health. Moreover, the bioavailable colloidal form of 1,3-1,4 β D-glucan in the finished product endows it with a functional role that has been demonstrated in clinical trials.

Industrial manufacture of the product is carried out using methods by which it is possible to select raw material with the qualitative and quantitative characteristics of soluble edible oat fibres, extract them efficiently from the cell walls of oat bran and from the adjacent outer layers of the oat grains, transfer them to a colloidal solution for imparting standardized viscosity, combine in the product with live bacteria by two-stage fermentation and provide directed prophylactic action of the finished product on human health.

The present invention further provides in a third embodiment a process for making an oat-based probiotic food product, which is of a relatively low viscosity, such that it is suitable for drinking.

The process of the third embodiment involves the following steps:

1) Preparation of the starting materials: a heat-treated raw oat component, an oat bran component and a fermented oat component.

The heat-treated raw oat component is formed from oats that have been heat-treated until substantially all of the starch has gelatinized (i.e. until at least 90% DSG (Degree of Starch Gelatinization) is reached, preferably at least 99% DSG, preferably about 100% DSG). The heat treatment is preferably carried out in the presence of steam. The heat treatment may involve thermally heating the oats in a fluidised bed. The heat treatment may be carried out a temperature of 90° C. or above, preferably at a temperature of from 96 to 100° C. The heat treatment preferably lasts for 40 minutes or more, preferably of from 50 to 60 minutes. Preferably, the heat-treated oats give a negative result in the peroxidase test, which is known to the skilled person, indicating that the peroxidase enzyme in the oats has been inactivated (denatured).

The Degree of Starch Gelatinization (DSG, %) is a standard measure in the art. Methods to determine DSG can be found in the following papers: Starch (2003), Volume 55, Issue 9 , Pages 403-409 (author: Paola et al; Title: Evaluation of the Degree of Starch Gelatinization by a New Enzymatic Method); Journal of Food Science (1980); 45:71-74 (author: Lineback et al; Title Gelatinization of Starch in Baked Products); and Cereal Chemistry 2004, Volume 81, Number 1 Pages 6-9 (Author Marconi et al; Title: A Maltose Biosensor for Determining Gelatinized Starch in Processed Cereal Foods).

The heat-treated oats are then soaked in water for a period of from 10 to 40 minutes, preferably 30 minutes and preferably at a temperature of from 15 to 20° C. The oat particles are then sliced, preferably so that at least 90% by weight of the particles have a maximum diameter of 500 μm or less, preferably a maximum diameter of 100 μm or less, preferably a maximum diameter of 80 μm or less, preferably using a slicing machine. Such slicing machines are commercially available. The oat particles are preferably subjected to the slicing process for a period of from 1 to 20 minutes, more preferably from 5 to 15 minutes, most preferably from 7 to 10 minutes, preferably at a temperature of from 18 to 20° C. The present inventors have found that it is advantageous to slice the heat-treated oat particles into thin layers, as it increases the uniformity of the oat bran particles and endosperms and promotes destruction of intercellular bonds, which in turn promotes extraction of 1,3-1,4 β D-glucan and starch from the oat particles and granules. Alternatively, the oats may be subjected to a grinding process, as described herein. Following the slicing or grinding process, the oats are steeped in water, preferably for a further 5 to 20 minutes, most preferably about 10 minutes, preferably at a temperature of from about 18 to 20° C., to form the heat-treated raw oat component. The w/w ratio of oat material:water in the heat treated raw oat component is preferably 1:10 to 1:1, more preferably 1:3 to 1:5, most preferably about 1:4.

The oat bran component may comprise an aqueous suspension of ground oat bran. The aqueous suspension of oat bran may be formed using the following process. First, oat bran is sieved, preferably using a sieve having apertures with a diameter of from 1 to 5 mm, preferably of from 1 to 3 mm, most preferably about 2 mm. The oat bran is then soaked in water, preferably for about 10 to 40 minutes, more preferably for about 15 to 30 minutes, most preferably for about 25 minutes, preferably at a temperature of from 15 to 20° C. The oat bran is then ground in the water, preferably for a period of about 5 to 20 minutes, more preferably for a period of about 5 to 15 minutes, most preferably for about 7 minutes, preferably at a temperature of from 15 to 20° C. This is preferably followed by a cold extraction of 1,3-1,4 β D-glucan by steeping the oat bran in water without grinding, preferably for a further 5 to 30 minutes, more preferably for about 5 to 20 minutes, most preferably about 12 minutes, preferably at a temperature of from 15 to 20° C. The oat bran is then preferably subjected to a warm extraction of 1,3-1,4 β D-glucan by steeping the oats in water, preferably for a period of about 5 to 20 minutes, more preferably for a period of about 5 to 15 minutes, most preferably for about 7 minutes, the temperature being raised over this period to a temperature of up to 65° C. to form an aqueous suspension of ground oat bran. The w/w ratio of oat bran material:water in the aqueous suspension of ground oat bran is preferably 1:10 to 1:1, more preferably 1:1 to 1:5, more preferably about 1:2 to 1:3, most preferably about 1:2.5.

The fermented oat component is formed by fermenting oat material with malted cereal material, preferably malted oat and/or malted barley, most preferably malted barley. In terms of the dry weights of the oat material and malted cereal, the proportion of oat material:malted cereal in the first fermentation step may be 1:10 to 10:1, preferably 1:1 to 1:10, more preferably 1:2 to 1:4, most preferably about 1:3. Most preferably, before combination with the malted cereal material, the oat particles of the oat material are subjected to a slicing process, as described above, mixed with water and malted barley material, then allowed to ferment. The oats and malted barley may undergo fermentation due to the native species of microorganisms present in the oats and/or barley, including microorganisms such as yeasts, lactobacteriums and moulds. Following fermentation, the mixture is then filtered, preferably using a sieve that has apertures having cross sectional areas of 5 mm² or less, more preferably having a cross sectional areas of 3 mm² or less, most preferably a cross sectional area of 1 mm² or less, and boiled. It may then be concentrated, if required, using evaporation such that the Brix content of the mixture is about 50 to 80° Bx, most preferably 65 to 70° Bx. The Brix content may be measured using any of the known means, such as refractometer.

2) The heat-treated raw oat component and the oat bran component are mixed together with water. In terms of the dry weights of the heat-treated raw oat component and oat bran component, the proportion of heat-treated raw oat component:oat bran component in the aqueous mixture may be 1:10 to 10:1, preferably 1:1 to 1:10, more preferably 1:2 to 1:4, most preferably about 1:3. Preferably, the aqueous mixture formed contains from about 3 to 10% by weight solids, more preferably of from 3 to 7% by weight solids, most preferably 5 to 6% by weight solids.

3) The aqueous mixture from step 2) is heated, preferably at a temperature of from 65 to 78° C., preferably for a period of from 5 to 20 minutes, most preferably for a period of from 8 to 15 minutes, most preferably for about 12 minutes, to warm extract starch and 1,3-1,4 β D-glucan from the oats, while simultaneously subjecting the mixture to an ultrasonic treatment, as described above.

4) The mixture from step 3) is then homogenised, preferably by being centrifuged, preferably at a temperature of from 65 to 75° C., most preferably 68 to 70° C., and preferably at a rotational speed of 1500 to 3000 revolutions per minute (rpm), preferably using a centrifuge having sieves with apertures having a cross-sectional area of 0.8×0.8 mm² to form a homogenous suspension (i.e. the portion from which the larger particles have been removed).

5) The homogenous suspension from step 4) is combined with the fermented oat component, then the mixture sterilised, preferably by heating the resultant mixture at a temperature of from 70 to 100° C., preferably for 30 to 40 minutes. In terms of solids content, the amount of fermented oat material in the total amount of oat material in the mixture may be less than 25 wt %, preferably of from 1 to 20 wt %, more preferably 1 to 10 wt %, most preferably of from 3 to 8 wt %. The temperature of this mixture is preferably raised to 95° C. or more, preferably about 100° C. over a period of 20 to 30 minutes, preferably 15 minutes, and then held at 95° C. or more, preferably about 100° C., for a further period of from 5 to 15 minutes, preferably 10 minutes.

6) The suspension from step 5) is then cooled to 42° C. or below, preferably in a continuous tube-like cooling element.

7) The suspension from step 6) is then inoculated with Lactobacteria and Bifidobacteria.

8) The suspension is fermented for a period of from 6 to 10 hours, preferably 8 to 9 hours, at a temperature of from 37 to 42° C.

9) The fermented suspension is then cooled to a temperature of 10° C. or less.

10) The suspension may then be mixed with fruits up to a content of 17% by weight of fruit.

11) The suspension from step 10) may then be packaged in an air-tight container.

12) The packaged suspension is preferably then kept at a temperature of from 2 to 4° C. for 24 to 48 hours to ripen the product.

The present invention further provides in a fourth embodiment a process for making an oat-based probiotic fluid food product, which has a relatively high viscosity, i.e. having a yogurt-like consistency.

The process of the fourth embodiment involves the following steps:

1) Preparation of the starting materials: a heat-treated raw oat component, an oat bran component and a fermented oat component.

The heat-treated raw oat component is preferably formed from oats that have been heat-treated until preferably the DSG in the oats is about 30 to 70%, more preferably 40 to 60%, most preferably about 50%. The heat treatment is preferably carried out in the presence of steam. The heat treatment may involve thermally heating the oats in a fluidised bed. The heat treatment may be carried out a temperature of 90° C. or above, preferably at a temperature of from 96 to 102° C. The DSG (Degree of Starch Gelatinization) is measured as described above. In this embodiment, it is preferred that the DSG of the starch is within the above ranges, since it has been found that the resultant oat-based food product has a thicker consistency than one made from oats in which all or nearly all of the starch has been gelatinized. This thicker consistency means the food product is more suitable as a “spoonable product”, i.e. one that can be eaten with a spoon.

The heat-treated oats are then soaked in water for a period of from 10 to 40 minutes, preferably 30 minutes, and preferably at a temperature of from 15 to 20° C. The oat particles are then sliced, preferably so that at least 90% by weight (preferably at least 95% by weight) of the particles have a maximum diameter of 500 μm, preferably a maximum diameter of 100 μm, more preferably a maximum diameter of 80 μm or less, preferably using a slicing machine. Such slicing machines are commercially available. The oat particles are preferably subjected to the slicing process for a period of from 1 to 20 minutes, more preferably from 5 to 15 minutes, most preferably from 7 to 10 minutes, preferably at a temperature of from 18 to 20° C. The present inventors have found that it is advantageous to slice the heat-treated oat particles into thin layers, as it increases the uniformity of the oat bran particles and endosperms and promotes destruction of intercellular bonds, which in turn promotes extraction of 1,3-1,4 β D-glucan and starch from the particles. Alternatively, the oats may be subjected to a grinding process, as described herein. Following the slicing or grinding process, the oats are steeped in water, preferably for a further 5 to 20 minutes, most preferably about 10 minutes, preferably at a temperature of from about 18 to 20° C., to form the heat-treated raw oat component. The w/w ratio of oat material:water in the heat treated raw oat component is preferably 1:10 to 1:1, more preferably 1:3 to 1:5, most preferably about 1:4.

The oat bran component may comprise an aqueous suspension of ground oat bran. The aqueous suspension of oat bran may be formed using the following process. First, oat bran is sieved, preferably using a sieve having apertures with a diameter of from 1 to 5 mm, preferably of from 1 to 3 mm, most preferably about 2 mm. The oat bran is then soaked in water, preferably for about 10 to 40 minutes, more preferably for about 15 to 30 minutes, most preferably for about 25 minutes, preferably at a temperature of from 15 to 20° C. The oat bran is then ground in the water, preferably for a period of about 5 to 20 minutes, more preferably for a period of about 5 to 15 minutes, most preferably for about 7 minutes, preferably at a temperature of from 15 to 20° C. This is preferably followed by a cold extraction of 1,3-1,4 β D-glucan by steeping the oat bran in water without grinding, preferably for a further 5 to 30 minutes, more preferably for about 5 to 20 minutes, most preferably about 12 minutes, preferably at a temperature of from 15 to 20° C. The oat bran is then preferably subjected to a warm extraction of 1,3-1,4 β D-glucan by steeping the bran in water, preferably for a period of about 5 to 20 minutes, more preferably for a period of about 5 to 15 minutes, most preferably for about 7 minutes, the temperature being raised over this period to a temperature of up to 65° C. to form an aqueous suspension of ground oat bran. The w/w ratio of bran material:water in the aqueous suspension of ground oat bran is preferably 1:10 to 1:1, more preferably 1:3 to 1:5, most preferably about 1:4.

The fermented oat component is formed by fermenting oat material with malted cereal material, preferably malted oat and/or malted barley, most preferably malted barley. In terms of the dry weights of the oat material and malted cereal, the proportion of oat material:malted cereal in the first fermentation step may be 1:10 to 10:1, preferably 1:1 to 1:10, more preferably 1:2 to 1:4, most preferably about 1:3. Most preferably, before combination with the malted cereal material, the oat particles of the oat material are subjected to a slicing process, as described above, mixed with water and malted barley material, then allowed to ferment. The oats and malted barley will undergo fermentation due to the native species of microorganisms present in the oats and/or barley, including microorganisms such as yeasts, lactobacteriums and moulds. Following fermentation, the mixture is then filtered, preferably using a sieve that has apertures having cross sectional areas of 5 mm² or less, more preferably having a cross sectional areas of 3 mm² or less, most preferably a cross sectional area of 1 mm² or less, and boiled. It may then be concentrated, if required, using evaporation such that the Brix content of the mixture is about 50 to 80 ° Bx, most preferably 65 to 70 ° Bx. The Brix content may be measured using any of the known means, such as refractometer. The w/w ratio of oat material:water in the fermented oat component is preferably 1:10 to 1:1, more preferably 1:3 to 1:5, most preferably about 1:4.

2) The heat-treated raw oat component, the non-heat treated raw oat component and the oat bran component are mixed together with water. In terms of the dry weights of the heat-treated raw oat component and oat bran component, the proportion of heat-treated raw oat component: oat bran component in aqueous mixture may be 1:10 to 10:1, preferably 1:1 to 1:10, more preferably 1:2 to 1:4. Preferably the aqueous mixture formed contains of from 5 to 20% by weight solids, more preferably 8 to 12% most preferably 9.5 to 10% by weight solids.

3) The aqueous mixture from step 2) is heated, preferably at a temperature of from 50 to 60° C., preferably for 5 to 20 minutes, more preferably for a period of from 8 to 15 minutes, most preferably 12 minutes to extract starch and 1,3-1,4 β D-glucan from the oats, while simultaneously subjecting the mixture to an ultrasonic treatment, as described above.

4) The mixture from step 3) is then homogenised, preferably by being centrifuged, preferably at a temperature of from 65 to 75° C., most preferably 68 to 70° C., and preferably at a rotational speed of 1500 to 3000 revolutions per minute (rpm), preferably using a centrifuge having sieves with apertures having a cross-sectional area of 0.8 x 0.8 mm² to form a homogenous suspension (i.e. the portion from which the larger particles have been removed).

5) The homogenous suspension from step 4) is combined with the fermented oat component, then the mixture sterilised, preferably by heating the resultant mixture at a temperature of from 70 to 100° C., preferably for 30 to 40 minutes. In terms of solids content, the amount of fermented oat material in the total amount of oat material in the mixture may be less than 25 wt %, preferably of from 1 to 20 wt %, more preferably from 1 to 10 wt %, most preferably of from 3 to 8 wt %. The temperature of this mixture is preferably raised over to 95° C. or more, preferably about 100° C. over a period of 20 to 30 minutes, preferably 15 minutes, and then held at 95° C. or more, preferably about 100° C., for a further period of from 5 to 15 minutes, preferably 10 minutes.

6) The suspension from step 5) is then cooled to 42° C. or below, preferably in a continuous tube-like cooling element.

7) The suspension from step 6) is then inoculated with Lactobacteria and Bifidobacteria.

8) The suspension is fermented for a period of from 6 to 10 hours, preferably 8 to 9 hours, at a temperature of from 37 to 42° C.

9) The fermented suspension is then cooled to a temperature of 10° C. or less.

10) The suspension may then be mixed with fruits up to a content of 17% by weight of fruit.

11) The suspension from step 10) may then be packaged in an air-tight container.

12) The packaged suspension is preferably then kept at a temperature of from 2 to 4° C. for 24 to 48 hours to ripen the product.

Embodiments of the present invention will now be illustrated in a non-limiting way in the following Examples, with reference to the drawings, in which:

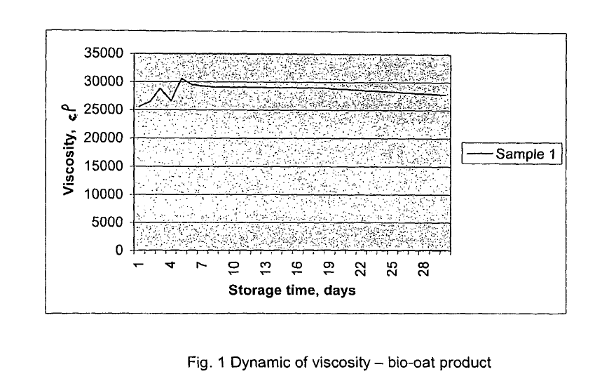

FIG. 1 shows the change in viscosity over a period of 28 days of the pro-biotic oat-based fluid food product produced in Examples 1 and 2; and

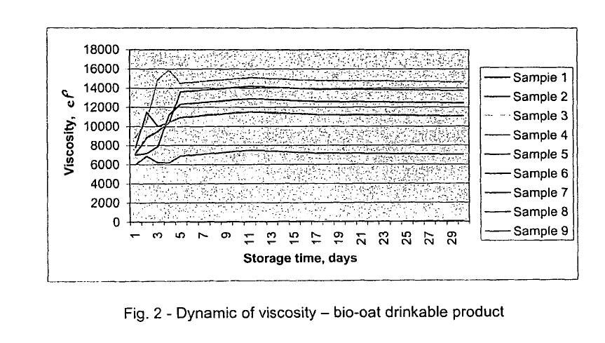

FIG. 2 shows the change in viscosity over a period of 28 days of nine samples of pro-biotic oat-based fluid food product produced in accordance with Example 6.

### EXAMPLES

### Example 1

### Production of a Bio-Oat Food Product

### Preparation of the Oat Raw Material and Derivatives Thereof for Industrial Production of the Product

The following oats and derivatives thereof are used as raw material in the manufacture of the product: raw oats, coarse-ground oatmeal and malted oats, characterized by a content of 1,3-1,4 β D-glucan of at least 5 wt %, and oat bran, characterized by a content of 1,3-1,4 β D-glucan of at least 10 wt %.

Before entering the main process, each of the aforementioned raw material components is checked for:
percentage by weight of dry matter/moisture according to GOST 3626/GOST 26312.7-88 “Groats. Method of determination of water content”. The method is based on thorough drying of the oats in a drying cabinet at a temperature of 140° C. for 40 minutes.
standardized amount of 1,3-1,4 β D-glucan by the method of the American Association of Cereal Chemists (AACC) Method 32-23 [Approved Methods of the American Association of Cereal Chemists (AACC)—10th Edition—Including 2001, 2002 and 2003 Supplements]. The method of the AACC is based on enzymatic cleavage of the molecules of beta-glucan by the enzyme beta-glucosidase followed by photometric measurement of the intensity of coloration of the solution;
acidity—in accordance with GOST 26971-86. The method is based on titration of the acidic substances with an aqueous suspension of oats.

The following are used in the manufacture of the product:
water to San-PiN 2.1.4.559-96 “DRINKING WATER. Hygienic requirements on water quality in centralized water supply systems. Quality control”; the following standards are used when checking the quality of process water: GOST 8.563-96 and GOST 8.556-91, stipulated values of error coefficients, which do not exceed the error norms according to GOST 27384-87; water purified in filtration plant to remove excessive content of calcium, iron and aluminium ions, as it has been demonstrated experimentally that decrease in the content of these ions promotes the formation of a more flexible and stable colloidal system, and absence of coliform bacteria in 100 ml guarantees hygienic parameters of the process.
bacterial starter of 5 cultures: namely, lactic acid bacteria Lactobacillus plantarum and Leuconostoc mesenteroides, yeasts—Pediococcus cerevisiae, Saccharomyces cerevisiae and bacteria—Bacillus subtilis, by dilution of the specified amount in a 0.5% fructose solution, initial content of CFU in 1 g—from 10E5 to 10E10 CFU in 1 g—MUK 4.2.577-96, GOST R. 52357-05, GOST R. 51331-99, GOST 10444.1-89;
bacterial starter comprising probiotic cultures, initial content of CFU in 1 g—from 10E5 to 10E10 CFU in 1 g—MUK 4.2.577-96, GOST R. 52357-05, GOST R. 51331-99, GOST 10444.1-89.

### Process of Primary Processing of the Prepared Raw Material

1. Malting of Oats

The raw oats undergo cleaning to remove impurities, sorting and steeping in sterile water at a temperature of 10-16° C. Germination is carried out in special troughs in malthouses at a temperature of 13-16° C. The process takes 3-4 days. This is followed by drying to water content of 10%, hulling using centrifugal hulling machines, polishing using a polisher, sifting on a vibratory sieve, grinding in a hammer mill to particle size max. 60 μm. Next, the raw material is sent for mixing with thermized coarse-ground oatmeal.

The malting process is based on natural enzymatic action: activation and functioning of naturally present amylolytic and other enzymes, development of special taste and consistency of the oats for obtaining the nutrients necessary for the growth and development of the probiotic bacteria used in the secondary fermentation, improvement of assimilability of the nutrients of the finished product. Enzymatic hydrolysis of the starch grains during malting is effected by amylases that are present in the oat grain.

Weakening of the intercellular bonds, loosening of the structure of the oat grains, and improvement in access to the cellular content of nutrients lead to transformation of proteins, carbohydrates, vitamins and minerals to forms that are more easily assimilated.

2. Coarse-Ground Oatmeal

The oatmeal undergoes dry heat treatment in a contact steam heater at temperature of the heating surface of 180-200° C., then sifting through a vibratory sieve and cooling with sterile air. It is mixed with ground malted oats in proportions 1:3. Then it is mixed with boiled process water, cooled to 45° C. in proportions 1:2.5 with final temperature of the mixture from 30 to 37° C.

The primary starter is prepared from 5 cultures: lactic acid bacteria Lactobacillus plantarum and Leuconostoc mesenteroides, yeasts—Pediococcus cerevisiae, Saccharomyces cerevisiae and bacteria—Bacillus subtilis—by diluting the specified amount in 0.5% fructose solution. The aqueous mixture obtained above is inoculated with the prepared starter.

Primary fermentation is carried out using the stock culture, observing the following process variables:
Temperature—30-37° C.
Fermentation time—10-36 hours
Viscosity after primary fermentation: 1000 to 10 000 cP.

Primary fermentation is carried out until the mixture has viscosity from 1000 to 10 000 cP, pH from 3.2 to 4.5, content of growth factors for the probiotic bacteria of the second stage of fermentation—vitamins and minerals: E, from 0.1 to 0.6 mg/100 g; D, from 0.1 to 0.4 μg/100 g; B1, from 0.01 to 0.1 mg/100 g; B2, from 0.05 to 0.15 mg/100 g; PP, from 0.05 to 0.15 mg/100 g; folic acid, from 0.1 to 3.0 μg/100 g; iron, from 0.5 to 1.5 mg/100 g; zinc, from 0.2 to 0.4 mg/100 g; iodine, from 0.1 to 0.4 mg/100 g.

This is followed by thermal drying in a fluidized bed at a temperature not exceeding 96-102° C., to water content of 6%, cooling and grinding in a hammer mill to particle size not greater than 60 μm.

3. Raw Oats

Preparation of the raw oats for secondary fermentation is carried out in two stages.

First stage: production of heat-treated rolled oat flakes with maximum possible disruption of the intercellular structure, “roasted” taste and standardized degree of thermal modification of the starch grains.

Second stage: production of an aqueous suspension for thermal hydrolysis and feed of the raw material to the main process—secondary fermentation.

The first stage comprises: cleaning to remove impurities, using a grain cleaner and boulter; sorting using a sorting drum, hulling using a centrifugal hulling machine; polishing using a polishing machine. This is followed by steaming using a continuous steamer under steam pressure of 2.5 atm for 45 minutes; rolling using a flaker to give flake thickness of 0.3-0.5 mm with standardized angle of advance of roll rotation for shearing disruption of the intercellular structures; drying using a continuous dryer to water content not greater than 10%.

The second stage comprises: steeping in water at a temperature not above 15° C., with ratio of oats to water of 1:1.5; wet grinding using a colloid mill to particle size not greater than 50 μm and hydrothermal treatment using a cooker at a temperature of 105° C. for 30 minutes. The raw material then enters the main process for secondary fermentation.

4. Oat Bran

The oat bran is dissolved in water at ratio of oats to water 1:1.5, leaving for 40 minutes for soaking of the bran and production of a suspension.

Cold extraction is carried out using simultaneous circulation and microgrinding of the suspension by passing it through a colloid mill.

The mixture is then submitted to thermal extraction of 1,3-1,4 β D-glucan from the bran by gradual raising of the temperature from 15° C. to the temperature of dextrinization of oat starch, in order to avoid this process.

Subsequent treatment of the suspension is carried out in apparatus built into the circulation system, with a UZGZ-4 ultrasonic generator, in which intensive extraction of the molecules of 1,3-1,4 β D-glucan takes place at the molecular level under the continuous action of high-intensity mechanical vibrations in the ultrasonic range, and they then dissolve. The treatment time, determined experimentally, ranges from 5 to 20 minutes.

The pH solution is corrected to pH from 5.9 to 6.2.

Homogenization is carried out in a homogenizer, where the solution is forced at high pressure (15-20 mPa) through narrow slots. As a result of these stresses, the high-molecular molecules of various sizes are stretched out and finely intermingled, creating a stable colloidal system of a solution with stable viscosity.

Stabilization of the colloidal solution is achieved by homogenization of the solution for 7-15 minutes to viscosity from 5000 to 35 000 cP.

### Process for Secondary Treatment of the Raw Material

The processed components: coarse-ground oatmeal, malted oats, raw oats and oat bran, are mixed in the proportions 1:1:5:7, adding water up to dry matter content from 6.0 to 40.0 wt. %, followed by homogenization to obtain a homogeneous suspension. The homogeneous suspension obtained is submitted to thermal sterilization in a continuous tubular heat exchanger up to a temperature of 135° C., holding at this temperature for 45-60 s and then cooling to a temperature not above 43° C.

A starter is prepared from probiotic cultures: Lactobacillus acidophilus and Bifidobacterium. For secondary fermentation, the mixture is inoculated with the prepared starter of probiotic cultures: Lactobacillus acidophilus and Bifidobacterium.

Secondary fermentation is carried out, using the following process variables:
Fermentation time: 9-16 h.
Residual oxygen in the headspace: 3-7%.
Quantity of probiotic bacteria in 1 g of fermented base, CFU-10E 8-10E11.
Viscosity of the base from secondary fermentation: 18 000-45 000 cP.

During secondary fermentation there is development of the probiotic bacteria to 10E8-10E11 CFU/g, hydrolysis of carbohydrates and proteins to simpler compounds, formation of exopolysaccharides, accumulation of lactic acid to 20-100 degrees Thöner, decrease of pH from 3.2 to 4.5, development of viscosity for the product from 18 000 to 45 000 cP.

The product is cooled to temperature from +2 to +6° C. and viscosity of 20 000-80 000 cP and, preferably, to viscosity of 20 000-60 000 cP.

Thus, the viscosity of the finished product is determined by three factors:
the colloidal system of molecules of 1,3-1,4 β D-glucan,
the polysaccharides of cellulose and starch that have undergone thermal modification,
exopolysaccharides—products of fermentation of the total mixture by microorganisms.

FIG. 1 gives a graph showing the variation in viscosity of the finished product as a function of time. As can be seen from FIG. 1, the viscosity remains stable throughout the envisaged shelf life of the product. The stability of the viscosity index confirms that the product does not separate into layers over the shelf life of the product (30 days).

As a result, a bio-oat food product is obtained, having the nutritional value and parameters presented in Table 1, in which the data concerning bacteria refer to the last day of product shelf life.

The indices characterizing the product, shown in Table 1, confirm its high nutritional and biological value, promoting a curative and prophylactic effect. In particular, the product has viscosity of 20 000-80 000 cP and, preferably, viscosity of 20 000-60 000 cP, providing it with coating properties, which in conjunction with a glycaemic index from 40 to 60 units, helps to lower the rate of assimilation of glucose into the blood and appearance of glucose peaks, prolongs the sensation of satiation, promotes lowering of the level of bad cholesterol, and ensures effective evacuation of the products of metabolism; the low pH of the product provides antimicrobial action on the causative agents of intestinal infections, promotes ionization of calcium and its rapid absorption into the blood, as well as improvement of absorption of phosphorus, potassium and other trace elements.

It should be noted that only the stated standards of the raw material and adherence to the recipe, including the qualitative and quantitative composition of components, ensure production of a finished product with the specified standards (at least 0.4 wt. %) of the content of high-molecular soluble edible oat fibres—1,3-1,4 β D-glucan.

### Example 2

### Production of Bio-Oat Food Product

The product is prepared as in Example 1, except that a starter is prepared from the following probiotic cultures for carrying out the secondary fermentation: Lactobacillus rhamnosus and Bifidobacterium. For carrying out the secondary fermentation, the mixture is inoculated with the starter prepared from probiotic cultures: Lactobacillus rhamnosus and Bifidobacterium.

As a result, a bio-oat food product is obtained, having the nutritional value and parameters shown in Table 1.

### Example 3

### Production of Bio-Oat Food Product

The product is prepared as in Example 1, except that a starter is prepared from the following probiotic cultures for carrying out the secondary fermentation: Lactobacillus plantarum, and/or Lactobacillus paracasei, and/or Lactobacillus casei. For carrying out the secondary fermentation, the mixture is inoculated with the starter prepared from probiotic cultures: Lactobacillus plantarum, and/or Lactobacillus paracasei, and/or Lactobacillus casei.

As a result, a bio-oat drinkable food product is obtained, having the nutritional value and parameters shown in Table 1.

### Example 4

### Production of Bio-Oat Food Product

The product is prepared as in Example 1, except that a starter is prepared from the mixture of probiotic cultures according to Example 3 and the following commercial cultures, for carrying out the secondary fermentation: Streptococcus thermophilus, and/or Lactobacillus bulgaricus, and/or Streptococcus lactis, and/or Streptococcus cremoris, and/or Streptococcus diacetylactis, and/or Lactococcus lactis, Lactococcus cremoris, and/or Lactococcus diacetylactis, and/or Lactobacillus helveticus, and/or Lactobacillus lactis, and/or Lactobacillus delbruekii, and/or Propionibacterium spp, and/or Kluyveromyces lactis.

As a result, a bio-oat food product is obtained, having the nutritional value and parameters shown in Table 1.

TABLE 1

| | | Unit of | | Method of |
|---|---|---|---|---|
| No. | Parameter | measurement | Standard | determination |
| 1 | Appearance | | Thick, viscous product | GOST 26809-86 |
| 2 | Consistency | | From viscous, gel-like | GOST 26809-86 |
| | | | to thick jelly-like, | |
| | | | retaining its shape | |
| 3 | Colour of product | | From milky to light- | GOST 26809-86 |
| | (without adding fillers) | | brown and brown, | |
| | | | of various shades | |
| 4 | Calorific value | kcal/100 g | 20-40 | Calculated by the |
| | | | | method of A. A. |
| | | | | Pokrovskii |
| 5 | Percentage by weight | wt. % | 6.0-11.0 | GOST 3626 |
| | of dry matter | | | |
| 6 | pH | | 3.2-4.5 | GOST R 51881-2002 |
| 7 | 1,3-1,4 β D-glucan | wt. % | 0.5-0.8 | AACC Method 32-23 |
| 8 | Viscosity | cP | 20 000-60 000 | Brookfield |
| 9 | Lactobacteria | CFU/1 g | 10 000 000 | GOST 10444.1-89 |
| 10 | Bifidobacteria | CFU/1 g | 10 000 000 | MUK 4.2.577-96. |
| | | | | GOST R 52357-05, |
| | | | | GOST R 51331-99 |
| 11 | Glycaemic index | units | 40-60 | Miller, J. B., Foster- |
| | | | | Powell, K., |
| | | | | Colagiuri, S., |
| | | | | Leeds, A., 1998, |
| | | | | “The GI” |
| | | | | “The glucose |
| | | | | revolution.”, |
| | | | | Hodder, Australia. |
| 12 | Vitamin E | mg/100 g | 0.1-0.6 | “Handbook of |
| 13 | Vitamin D | μg/100 g | 0.1-0.4 | methods of analysis |
| 14 | Vitamin B1 | mg/100 g | 0.01-0.1 | of the quality and |
| 15 | Vitamin B2 | mg/100 g | 0.05-0.15 | safety of food |
| 16 | Vitamin PP | mg/100 g | 0.05-0.15 | products”, edited by |
| 17 | Folic acid | μg/100 g | 1.0-3.0 | I. M. Skurikhin, V. A. |
| 18 | Iron | mg/100 g | 0.5-1.5 | Tutel'yan, p. 340, M. |
| 19 | Zinc | mg/100 g | 0.2-0.4 | Brandes-Meditsina |
| 20 | Iodine | mg/100 g | 0.1-0.4 | |

### Example 5

### Production of a Bio-Oat Food Product Containing an Edible Filler

The product is prepared as in Example 1, except that prior to cooling of the product in a cold chamber at temperatures from +2 to +6° C., it is mixed with fillers that are used in the food industry (edible fillers), such as: vegetable and/or fruit purée (cooked, or cooked with sugar), or concentrated fruit and berry juices, or fruit and berry powders, or dry extracts of herbs, or liquid extracts of herbs, or nuts, or cereals, etc.

The edible filler can be used in the following proportions (wt % of the product):
vegetable and/or fruit purée 3-20 wt. %;
concentrated fruit and berry juices 1-7 wt. %;
fruit and berry powders 1-5 wt. %;
dry extracts of herbs 1-3 wt. %;
liquid extracts of herbs 1-7 wt. %;
nuts 1-5 wt. %;
cereals 1-5 wt. %.

As a result, a bio-oat food product containing filler is obtained, having the nutritional value and parameters shown in Table 2. The data on bacteria given in Table 2 refer to the last day of the shelf life.

TABLE 2

| | | Unit of | | Method of |
|---|---|---|---|---|
| No. | Parameter | measurement | Standard | determination |
| 1 | Appearance | | Thick, viscous product | GOST 26809-86 |
| 2 | Consistency | | From viscous, gel-like | GOST 26809-86 |
| | | | to thick jelly-like, | |
| | | | retaining its shape | |
| 3 | Colour of product (with | | Corresponds to the | GOST 26809-86 |
| | edible filler) | | colour of the filler | |
| 4 | Calorific value | kcal/100 g | 30-90 | Calculated by the |
| | | | | method of A. A. |
| | | | | Pokrovskii |
| 5 | Percentage by weight | wt. % | 7.0-40.0 | GOST 3626 |
| | of dry matter | | | |
| 6 | pH | | 3.2-4.5 | GOST R 51881-2002 |
| 7 | 1,3-1,4 β D-glucan | wt. % | 0.4-0.7 | AACC Method 32-23 |
| 8 | Viscosity | cP | 20 000-80 000 | Brookfield |
| 9 | Lactobacteria | CFU/1 g | 10 000 000 | GOST 10444.1-89 |
| 10 | Bifidobacteria | CFU/1 g | 10 000 000 | MUK 4.2.577-96. |
| | | | | GOST R 52357-05, |
| | | | | GOST R 51331-99 |
| 11 | Glycaemic index | units | 40-60 | Miller, J. B., Foster- |
| | | | | Powell, K., |
| | | | | Colagiuri, S., |
| | | | | Leeds, A., 1998, |
| | | | | “The GI” |
| | | | | “The glucose |
| | | | | revolution.”, |
| | | | | Hodder, Australia. |
| 12 | Vitamin E | mg/100 g | 0.1-0.6 | “Handbook of |
| 13 | Vitamin D | μg/100 g | 0.1-0.4 | methods of analysis |
| 14 | Vitamin B1 | mg/100 g | 0.01-0.1 | of the quality and |
| 15 | Vitamin B2 | mg/100 g | 0.05-0.15 | safety of food |
| 16 | Vitamin PP | mg/100 g | 0.05-0.15 | products”, edited by |
| 17 | Folic acid | μg/100 g | 1.0-3.0 | I. M. Skurikhin, V. A. |
| 18 | Iron | mg/100 g | 0.5-1.5 | Tutel'yan, p. 340, M. |
| 19 | Zinc | mg/100 g | 0.2-0.4 | Brandes-Meditsina |
| 20 | Iodine | mg/100 g | 0.1-0.4 | |

### Example 6

### Production of a Bio-Oat Drinkable Food Product

### Preparation of the Oat Raw Material and Derivatives Thereof for Industrial Production of the Product

The following oats and derivatives thereof are used as raw material in the manufacture of the product: raw oats, coarse-ground oatmeal and malted oats, characterized by a content of 1,3-1,4 β D-glucan of at least 5 wt %, and oat bran, characterized by a content of 1,3-1,4 β D-glucan of at least 10 wt %.

Before entering the main process, each of the aforementioned raw material components is checked for:
percentage by weight of dry matter/moisture according to GOST 3626/GOST 26312.7-88 “Groats. Method of determination of water content”. The method is based on thorough drying of the oats in a drying cabinet at a temperature of 140° C. for 40 minutes.
standardized amount of 1,3-1,4 β D-glucan by the method of the American Association of Cereal Chemists (AACC) Method 32-23 [Approved Methods of the American Association of Cereal Chemists (AACC)—10th Edition—Including 2001, 2002 and 2003 Supplements]. The method of the AACC is based on enzymatic cleavage of the molecules of beta-glucan by the enzyme beta-glucosidase followed by photometric measurement of the intensity of coloration of the solution;
acidity—in accordance with GOST 26971-86. The method is based on titration of the acidic substances with an aqueous suspension of oats.

The following are used in the manufacture of the product:
water to San-PiN 2.1.4.559-96 “DRINKING WATER. Hygienic requirements on water quality in centralized water supply systems. Quality control”; the following standards are used when checking the quality of process water: GOST 8.563-96 and GOST 8.556-91, stipulated values of error coefficients, which do not exceed the error norms according to GOST 27384-87; water purified in filtration plant to remove excessive content of calcium, iron and aluminium ions, as it has been demonstrated experimentally that decrease in the content of these ions promotes the formation of a more flexible and stable colloidal system, and absence of coliform bacteria in 100 ml guarantees hygienic parameters of the process.
bacterial starter of 5 cultures: namely, lactic acid bacteria Lactobacillus plantarum and Leuconostoc mesenteroides, yeasts—Pediococcus cerevisiae, Saccharomyces cerevisiae and bacteria—Bacillus subtilis, by dilution of the specified amount in a 0.5% fructose solution, initial content of CFU in 1 g—from 10E5 to 10E10 CFU in 1 g—MUK 4.2.577-96, GOST R. 52357-05, GOST R. 51331-99, GOST 10444.1-89;
bacterial starter comprising probiotic cultures, initial content of CFU in 1 g—from 10E5 to 10E10 CFU in 1 g—MUK 4.2.577-96, GOST R. 52357-05, GOST R. 51331-99, GOST 10444.1-89.

### Process of Primary Processing of the Prepared Raw Material

1. Malting of Oats

The raw oats undergo cleaning to remove impurities, sorting and steeping in sterile water at a temperature of 10-16° C. Germination is carried out in special troughs in malthouses at a temperature of 13-16° C. The process takes 3-4 days. This is followed by drying to water content of 10%, hulling using centrifugal hulling machines, polishing using a polisher, sifting on a vibratory sieve, grinding in a hammer mill to particle size max. 60 μm. Next, the raw material is sent for mixing with thermized oatmeal.

The malting process is based on natural enzymatic action: activation and functioning of naturally present amylolytic and other enzymes, development of special taste and consistency of the oats for obtaining the nutrients necessary for the growth and development of the probiotic bacteria used in the secondary fermentation, improvement of assimilability of the nutrients of the finished product. Enzymatic hydrolysis of the starch grains during malting is effected by amylases that are present in the oat grain. Weakening of the intercellular bonds, loosening of the structure of the oat grains, and improvement in access to the cellular content of nutrients lead to transformation of proteins, carbohydrates, vitamins and minerals to forms that are more easily assimilated.

2. Coarse-Ground Oatmeal

The oatmeal undergoes dry heat treatment in a contact steam heater at temperature of the heating surface of 180-200° C., then sifting through a vibratory sieve and cooling with sterile air. It is mixed with ground malted oats in proportions 1:3. Then it is mixed with boiled process water, cooled to 45° C. in proportions 1:2.5 with final temperature of the mixture from 30 to 37° C.

The primary starter is prepared from 5 cultures: lactic acid bacteria Lactobacillus plantarum and Leuconostoc mesenteroides, yeasts—Pediococcus cerevisiae, Saccharomyces cerevisiae and bacteria—Bacillus subtilis—by diluting the specified amount in 0.5% fructose solution.

The aqueous mixture obtained is inoculated with the prepared starter. Primary fermentation is carried out using the stock culture, observing the following process variables:
Temperature—30-37° C.
Fermentation time—10-36 hours
Viscosity after primary fermentation: 1000 to 20 000 cP.

Primary fermentation is carried out until the mixture has viscosity from 1000 to 20 000 cP, pH from 3.2 to 4.5, content of growth factors for the probiotic bacteria of the second stage of fermentation—vitamins and minerals: E, from 0.1 to 0.6 mg/100 g; D, from 0.1 to 0.4 μg/100 g; B1, from 0.01 to 0.1 mg/100 g; B2, from 0.05 to 0.15 mg/100 g; PP, from 0.05 to 0.15 mg/100 g; folic acid, from 0.1 to 3.0 μg/100 g; iron, from 0.5 to 1.5 mg/100 g; zinc, from 0.2 to 0.4 mg/100 g; iodine, from 0.1 to 0.4 mg/100 g.

This is followed by thermal drying in a fluidized bed at a temperature not exceeding 96-102° C., to water content of 6%, cooling and grinding in a hammer mill to particle size not greater than 60 μm.

3. Raw Oats

Preparation of the raw oats for secondary fermentation is carried out in two stages.

First stage: production of heat-treated rolled oat flakes with maximum possible disruption of the intercellular structure, “roasted” taste and standardized degree of thermal modification of the starch grains.

Second stage: production of an aqueous suspension for thermal hydrolysis and feed of the raw material to the main process—secondary fermentation.

The first stage comprises: cleaning to remove impurities, using a grain cleaner and boulter; sorting using a sorting drum, hulling using a centrifugal hulling machine; polishing using a polishing machine. This is followed by steaming using a continuous steamer under steam pressure of 2.5 atm for 45 minutes; rolling using a flaker to give flake thickness of 0.3-0.5 mm with standardized angle of advance of roll rotation for shearing disruption of the intercellular structures; drying using a continuous dryer to water content not greater than 10%.

The second stage comprises: steeping in water at a temperature not above 15° C., with ratio of oats to water of 1:1.5; wet grinding using a colloid mill to particle size not greater than 50 μm and hydrothermal treatment using a cooker at a temperature of 105° C. for 30 minutes. The raw material then enters the main process for secondary fermentation.

4. Oat Bran

The oat bran is dissolved in water at ratio of oats to water 1:1.5, leaving for 40 minutes for soaking of the bran and production of a suspension. Cold extraction is carried out using simultaneous circulation and microgrinding of the suspension by passing it through a colloid mill. The mixture is then submitted to thermal extraction of 1,3-1,4 β D-glucan from the bran by gradual raising of the temperature from 15° C. to the temperature of dextrinization of oat starch, in order to avoid this process.

Subsequent treatment of the suspension is carried out in apparatus built into the circulation system, with a UZGZ-4 ultrasonic generator, in which intensive extraction of the molecules of 1,3-1,4 β D-glucan takes place at the molecular level under the continuous action of high-intensity mechanical vibrations in the ultrasonic range, and they then dissolve. The treatment time, determined experimentally, ranges from 5 to 20 minutes. The pH of the solution is corrected from pH 5.9 to 6.2.

Homogenization is carried out in a homogenizer, where the solution is forced at high pressure (15-20 mPa) through narrow slots. As a result of these stresses, the high-molecular molecules of various sizes are stretched out and finely intermingled, creating a stable colloidal system of a solution with stable viscosity.

Stabilization of the colloidal solution is achieved by homogenization of the solution for 7-15 minutes to viscosity of 1000-20 000 cP.

### Process for Secondary Treatment of the Raw Material

The processed components: coarse-ground oatmeal, malted oats, raw oats and oat bran, are mixed in the proportions 1:3:11:15, adding water up to dry matter content from 2.5 to 20.0 wt. %, followed by homogenization to obtain a homogeneous suspension. The homogeneous suspension obtained is submitted to thermal sterilization in a continuous tubular heat exchanger up to a temperature of 135° C., holding at this temperature for 45-60 s and then cooling to a temperature not above 43° C.

A starter is prepared from probiotic cultures: Lactobacillus acidophilus and Bifidobacterium. For secondary fermentation, the mixture is inoculated with the prepared starter of probiotic cultures: Lactobacillus acidophilus and Bifidobacterium.

Secondary fermentation is carried out, using the following process variables:
Fermentation time: 9-16 h.
Residual oxygen in the headspace: 3-7%.
Quantity of probiotic bacteria in 1 g of fermented base CFU—10E8-10E11.
Viscosity of the base from secondary fermentation: 1000-30 000 cP.

During secondary fermentation there is development of the probiotic bacteria to CFU 10E8 10E11 CFU/g, hydrolysis of carbohydrates and proteins to simpler compounds, formation of exopolysaccharides, accumulation of lactic acid to 20-100 degrees Thörner, decrease of pH from 3.2 to 4.5, development of viscosity for the product from 1000 to 30 000 cP. The product is cooled from +2 to +6° C. in temperature and viscosity from 2000 to 50 000 cP and, preferably, to viscosity from 2000 to 40 000 cP.

Thus, the viscosity of the finished product is determined by three factors:
the colloidal system of molecules of 1,3-1,4 β D-glucan,
the polysaccharides of cellulose and starch that have undergone thermal modification,
exopolysaccharides—products of fermentation of the total mixture by microorganisms.

FIG. 2 gives a graph showing the variation in viscosity of nine samples of the finished product as a function of time. As can be seen from FIG. 2, the viscosity remains stable throughout the envisaged shelf life of the product. The stability of the viscosity index confirms that the product does not separate into layers over the shelf life of the product (30 days).

As a result, a bio-oat drinkable food product is obtained, having the nutritional value and parameters presented in Table 3, in which the data concerning bacteria refer to the last day of product shelf life. The indices characterizing the product, shown in Table 3, confirm its high nutritional and biological value, promoting a curative and prophylactic effect. In particular, the product has viscosity of 2000-50 000 cP and, preferably, viscosity of 2000-40 000 cP, providing it with coating properties, which in conjunction with a glycaemic index from 40 to 50 units, helps to lower the rate of assimilation of glucose into the blood and appearance of glucose peaks, prolongs the sensation of satiation, promotes lowering of the level of bad cholesterol, and ensures effective evacuation of the products of metabolism; the low pH of the product provides antimicrobial action on the causative agents of intestinal infections, promotes ionization of calcium and its rapid absorption into the blood, as well as improvement of absorption of phosphorus, potassium and other trace elements.

It should be noted that only the stated standards of the raw material and adherence to the recipe, including the qualitative and quantitative composition of components, ensure production of a finished product with the specified standards (at least 0.4 wt. %) of the content of high-molecular soluble edible oat fibres—1,3-1,4 β D-glucan.

### Example 7

### Production of Bio-Oat Drinkable Food Product

The product is prepared as in Example 6, except that a starter is prepared from the following probiotic cultures for carrying out the secondary fermentation: Lactobacillus rhamnosus and Bifidobacterium. For carrying out the secondary fermentation, the mixture is inoculated with the starter prepared from probiotic cultures: Lactobacillus rhamnosus and Bifidobacterium.

As a result, a bio-oat drinkable food product is obtained, having the nutritional value and parameters shown in Table 3.

### Example 8

### Production of Bio-Oat Drinkable Food Product

The product is prepared as in Example 6, except that a starter is prepared from the following probiotic cultures for carrying out the secondary fermentation: Lactobacillus plantarum, and/or Lactobacillus paracasei, and/or Lactobacillus casei. For carrying out the secondary fermentation, the mixture is inoculated with the starter prepared from probiotic cultures: Lactobacillus plantarum, and/or Lactobacillus paracasei, and/or Lactobacillus casei.

As a result, a bio-oat drinkable food product is obtained, having the nutritional value and parameters shown in Table 3.

### Example 9

### Production of Bio-Oat Drinkable Food Product

The product is prepared as in Example 6, except that a starter is prepared from the mixture of probiotic cultures according to Example 8 and the following commercial cultures, for carrying out the secondary fermentation: Streptococcus thermophilus, and/or Lactobacillus bulgaricus, and/or Streptococcus lactis, and/or Streptococcus cremoris, and/or Streptococcus diacetylactis, and/or Lactococcus lactis, Lactococcus cremoris, and/or Lactococcus diacetylactis, and/or Lactobacillus helveticus, and/or Lactobacillus lactis, and/or Lactobacillus delbruekii, and/or Propionibacterium spp, and/or Kluyveromyces lactis.

As a result, a bio-oat drinkable food product is obtained, having the nutritional value and parameters shown in Table 3.

TABLE 3

| | | Unit of | | Method of |
|---|---|---|---|---|
| No. | Parameter | measurement | Standard | determination |
| 1 | Appearance | | Homogenous | GOST 26809-86 |
| | | | colloidal liquid of | |
| | | | different viscosity | |
| 2 | Consistency | | Lightly fluid plastic, | GOST 26809-86 |
| | | | viscous, viscosity | |
| | | | from light to | |
| | | | middle level | |
| 3 | Colour of traditional | | From milky to light- | GOST 26809-86 |
| | product (without adding | | brown and brown, | |
| | fillers) | | of various shades | |
| 4 | Calorific value | kcal/100 g | 20-40 | Calculated by the |
| | | | | method of A. A. |
| | | | | Pokrovskii |
| 5 | Percentage by weight | wt. % | 2.5-9.0 | GOST 3626 |
| | of dry matter | | | |
| 6 | pH | | 3.2-4.5 | GOST R 51881-2002 |
| 7 | 1,3-1,4 β D-glucan | wt. % | 0.5-2.0 | AACC Method 32-23 |
| 8 | Viscosity | cP | 2000-40 000 | Brookfield |
| 9 | Lactobacteria | CFU/1 g | 10 000 000 | GOST 10444.1-89 |
| 10 | Bifidobacteria | CFU/1 g | 10 000 000 | MUK 4.2.577-96. |
| | | | | GOST R 52357-05, |
| | | | | GOST R 51331-99 |
| 11 | Glycaemic index | units | 40-50 | Miller, J. B., Foster- |
| | | | | Powell, K., |
| | | | | Colagiuri, S., |
| | | | | Leeds, A., 1998, |
| | | | | “The GI” |
| | | | | “The glucose |
| | | | | revolution.”, |
| | | | | Hodder, Australia. |
| 12 | Vitamin E | mg/100 g | 0.1-0.6 | “Handbook of |
| 13 | Vitamin D | μg/100 g | 0.1-0.4 | methods of analysis |
| 14 | Vitamin B1 | mg/100 g | 0.01-0.1 | of the quality and |
| 15 | Vitamin B2 | mg/100 g | 0.05-0.15 | safety of food |
| 16 | Vitamin PP | mg/100 g | 0.05-0.15 | products”, edited by |
| 17 | Folic acid | μg/100 g | 1.0-3.0 | I. M. Skurikhin, V. A. |
| 18 | Iron | mg/100 g | 0.5-1.5 | Tutel'yan, p. 340, M. |
| 19 | Zinc | mg/100 g | 0.2-0.4 | Brandes-Meditsina |
| 20 | Iodine | mg/100 g | 0.1-0.4 | |

### Example 10

### Production of a Bio-Oat Drinkable Food Product Containing an Edible Filler

The product is prepared as in Example 6, except that prior to cooling of the product in a cold chamber at temperatures from +2 to +6° C., it is mixed with fillers that are used in the food industry (edible fillers), such as: vegetable and/or fruit purée (cooked, or cooked with sugar), or concentrated fruit and berry juices, or fruit and berry powders, or dry extracts of herbs, or liquid extracts of herbs, or nuts, or cereals, etc.

The edible filler can be used in the following proportions (wt % in the product):
vegetable and/or fruit purée 3-20 wt. %;
concentrated fruit and berry juices 1-7 wt. %;
fruit and berry powders 1-5 wt. %;
dry extracts of herbs 1-3 wt. %;
liquid extracts of herbs 1-7 wt. %;
nuts 1-5 wt. %;
cereals 1-5 wt. %.

As a result, a bio-oat drinkable food product containing filler is obtained, having the nutritional value and parameters shown in Table 4. The data on bacteria given in Table 4 refer to the last day of the shelf life.

TABLE 4

| | | Unit of | | Method of |
|---|---|---|---|---|
| No. | Parameter | measurement | Standard | determination |
| 1 | Appearance | | Thick, viscous product | GOST 26809-86 |
| 2 | Consistency | | From viscous, gel-like | GOST 26809-86 |
| | | | to thick jelly-like, | |
| | | | retaining its shape | |
| 3 | Colour of traditional | | Corresponds to the | GOST 26809-86 |
| | product (with fillers) | | colour of the filler | |
| 4 | Calorific value | kcal/100 g | 20-35 | Calculated by the |
| | | | | method of A. A. |
| | | | | Pokrovskii |
| 5 | Percentage by weight | wt. % | 7.0-20.0 | GOST 3626 |
| | of dry matter | | | |
| 6 | pH | | 3.2-4.5 | GOST R 51881-2002 |
| 7 | 1,3-1,4 β D-glucan | wt. % | 0.4-1.6 | |
| 8 | Viscosity | cP | 4000-50 000 | Brookfield |
| 9 | Lactobacteria | CFU/1 g | 10 000 000 | GOST 10444.1-89 |
| 10 | Bifidobacteria | CFU/1 g | 10 000 000 | MUK 4.2.577-96. |
| | | | | GOST R 52357-05, |
| | | | | GOST R 51331-99 |
| 11 | Glycaemic index | units | 40-50 | Miller, J. B., Foster- |
| | | | | Powell, K., |
| | | | | Colagiuri, S., |
| | | | | Leeds, A., 1998, |
| | | | | “The GI” |
| | | | | “The glucose |
| | | | | revolution.”, |
| | | | | Hodder, Australia. |
| 12 | Vitamin E | mg/100 g | 0.1-0.6 | “Handbook of |
| 13 | Vitamin D | μg/100 g | 0.1-0.4 | methods of analysis |
| 14 | Vitamin B1 | mg/100 g | 0.01-0.1 | of the quality and |
| 15 | Vitamin B2 | mg/100 g | 0.05-0.15 | safety of food |
| 16 | Vitamin PP | mg/100 g | 0.05-0.15 | products”, edited by |
| 17 | Folic acid | μg/100 g | 1.0-3.0 | I. M. Skurikhin, V. A. |
| 18 | Iron | mg/100 g | 0.5-1.5 | Tutel'yan, p. 340, M. |
| 19 | Zinc | mg/100 g | 0.2-0.4 | Brandes-Meditsina |
| 20 | Iodine | mg/100 g | 0.1-0.4 | |

In all the above Examples, the products produced contain 1,3-1,4 β D-glucan having an average molecular weight of more than 1,500,000 Daltons (measured in accordance with the test method described in Rimstein et al, referenced herein).

The above Examples illustrate non-limiting ways in which the process of the present invention can be carried out. Two or more aspects from the different Examples above may be combined. Likewise, any aspect of the Examples is generally applicable, unless otherwise stated, and may be combined with any of the other embodiments or aspects of the invention as described herein.

1. A process for preparing a pro-biotic oat-based fluid food product, the process comprising:
A) a first fermentation step, involving the fermentation of oat material;
B) mechanically treating one or more unfermented oat-derived substances in the presence of water to form an aqueous suspension containing 1,3-1,4 β D-glucan in dissolved and/or suspended form, wherein the average molecular weight of the 1,3-1,4 β D-glucan in the suspension is at least 1,500,000 Daltons, and combining the products from the first fermentation step with the one or more oat-derived substances and the water, before, during or after the formation of the aqueous suspension; and
C) a second fermentation step, involving the fermentation of the aqueous suspension in the presence of Lactobacteria and/or Bifidobacteria, until the quantity of Lactobacteria is at least 10E7 CFU/g and/or the quantity of Bifidobacteria is at least 10E7 CFU/g.

2. The process according to claim 1, wherein the oats from which the oat material and the unfermented oat-derived substances are obtained contain at least 5 wt % of 1,3-1,4 β D-glucan.

3. The process according to claim 1, wherein, in step A, the oat material is fermented in the presence of malted cereal.

4.-6. (canceled)

7. The process according to claim 1, wherein the first fermentation step is carried out in the presence of yeast.

8. The process according to claim 1, wherein the first fermentation step comprises carrying out the fermentation of the oat material in water until a viscosity of from 1000 to 20,000 cP and a pH of 3.2 to 4.5 is reached.

9.-10. (canceled)

11. The process according to claim 1, wherein the process further comprises, prior to the first fermentation step, the production of malted cereal by the malting of cereal grains.

12. (canceled)

13. The process according to claim 1, wherein the mechanical treatment of step B comprises steeping the one or more unfermented oat-derived substances in water at a temperature of less than 68° C. to extract 1,3-1,4 β D-glucan from the oat-derived substances, wherein the one or more unfermented oat-derived substances are sliced and/or ground before, during or after the steeping.

14.-20. (canceled)

21. The process according to claim 1, wherein the mechanical treatment of step B involves subjecting the one or more unfermented oat-derived substances to ultrasonic radiation, while grinding/slicing and/or steeping the one or more unfermented oat-derived substances in water.

22. The process according to claim 1, wherein an aqueous suspension of ground oat bran is combined with an aqueous suspension of ground and/or sliced oatmeal to form the aqueous suspension in step B, and then the aqueous suspension is combined with the products from the first fermentation step.

23.-26. (canceled)

27. The process according to claim 1, wherein the aqueous suspension formed in step B and which contains the products from the first fermentation step has a solids content of from 2.5 to 20 wt %.

28. The process according to claim 1, wherein the suspension formed in step B is subjected to thermal sterilization, cooled to a temperature below 43° C., then inoculated with Lactobacteria and/or Bifidobacteria and subjected to the secondary fermentation of step (C).

29. The process according to claim 1, wherein, following the second fermentation, the product is cooled to a temperature of 15° C. or less.

30. The process according to claim 1, following the second fermentation, the product is cooled to a temperature of from 2 to 6° C.

31. (canceled)

32. The process according to claim 1, wherein the viscosity of the pro-biotic oat-based fluid food product formed in the process is from 2000 to 80,000 cP.

33.-34. (canceled)

35. A probiotic oat-based fluid food product comprising
a. 1,3-1,4 β D-glucan, wherein the average molecular weight of the 1,3-1,4 β D-glucan in the product is at least 1,500,000 Daltons;
b. 2.5 to 40 wt % solids, at least some of which is derived from oats;
c. at least 10E7 CFU/g Lactobacteria and/or at least 10E7 CFU/g Bifidobacteria;
d. with the remainder water.

36. The food product according to claim 35, wherein the product is obtainable by a process comprising:
A) a first fermentation step, involving the fermentation of oat material;
B) mechanically treating one or more unfermented oat-derived substances in the presence of water to form an aqueous suspension containing 1,3-1,4 β D-glucan in dissolved and/or suspended form, wherein the average molecular weight of the 1,3-1,4 β D-glucan in the suspension is at least 1,500,000 Daltons, and combining the products from the first fermentation step with the one or more oat-derived substances and the water, before, during or after the formation of the aqueous suspension; and
C) a second fermentation step, involving the fermentation of the aqueous suspension in the presence of Lactobacteria and/or Bifidobacteria, until the quantity of Lactobacteria is at least 10E7 CFU/g and/or the quantity of Bifidobacteria is at least 10E7 CFU/g.

37. The food product according to claim 35, wherein the food product has a glycaemic index of from 40 to 60 units.

38. The food product according to claim 35, wherein the food product has a pH of from 3.2 to 4.5.

39. The food product according to claim 35, wherein the food product has a viscosity of from 2000 to 80,000 cP.

40. (canceled)

41. A process for preparing a pro-biotic oat-based fluid food product, the process comprising:
A) mechanically treating one or more unfermented oat-derived substances in the presence of water to form an aqueous suspension containing 1,3-1,4 β D-glucan in dissolved and/or suspended form, wherein the average molecular weight of the 1,3-1,4 β D-glucan in the suspension is at least 1,500,000 Daltons, and combining fermented oat material with the one or more oat-derived substances and the water, before, during or after the formation of the aqueous suspension; and
B) a fermentation step, involving the fermentation of the aqueous suspension in the presence of Lactobacteria and/or Bifidobacteria, until the quantity of Lactobacteria is at least 10E7 CFU/g and/or the quantity of Bifidobacteria is at least 10E7 CFU/g.
